(19) United States
(12) Patent Application Publication
(10) Pub. No.: US 2026/0155660 A1
(43) Pub. Date: Jun. 4, 2026

(54) Smart Power Tool Battery Charger

(71) Applicant: Milwaukee Electric Tool Corporation, Brookfield, WI (US)

(72) Inventors: Jonathan E. Abbott, Milwaukee, WI (US); Asensio Lorenzo Sempere, Woodbury, MN (US); Michael David Kolden, Wauwatosa, WI (US); Paul Chao, Menomonee Falls, WI (US)

(21) Appl. No.: 18/704,030

(22) PCT Filed: Oct. 26, 2022
(86) PCT No.: PCT/US2022/047884

§ 371 Date: Apr. 23, 2024

Related U.S. Application Data
(60) Provisional application No. 63/272,589, filed on Oct. 27, 2021.

(51) Int. Cl. H02J 7/52; H01M 10/44; H02J 7/47; H02J 7/50; H02J 7/65; H02J 7/70; H02J 7/90; H02J 7/92; H02J 7/96

(52) U.S. Cl. CPC H02J 7/52; H01M 10/441; H01M 10/443; H02J 7/47; H02J 7/575; H02J 7/65; H02J 7/751; H02J 7/92; H02J 7/933; H02J 7/96; H02J 7/977

(57) ABSTRACT

A power tool battery charger and method for adaptive charging and data transfer is disclosed. A power tool battery charger may include one or more charging docks, each charging dock including a charging interface for providing charging current, and an electronic controller including a processor and a memory. The electronic controller is configured to identify one or more battery packs received by the charging docks and determine battery information for the one or more battery packs. The battery information indicating tandem use information for the one or more battery packs, end-of-use information for the one or more battery packs, or user preference information. The electronic controller also charges the one or more battery packs based on the battery information.

### RELATED APPLICATIONS

The present application is based on and claims priority from U.S. Patent Application No. 63/272,589, filed on Oct. 27, 2021, the entire disclosure of which is incorporated herein by reference.

### SUMMARY

Some embodiments of the disclosure provide a power tool battery charger for adaptive charging. A power tool battery charger may include one or more charging docks, each charging dock including a charging interface for providing charging current, and an electronic controller including a processor and a memory. The electronic controller is configured to identify one or more battery packs received by the one or more charging docks. The electronic controller also determines battery information for the one or more battery packs. The battery information includes one or more of: tandem use information for the one or more battery packs, end-of-use information for the one or more battery packs, or user preference information. The electronic controller charges the one or more battery packs based on the battery information.

Some embodiments of the disclosure also provide a power tool battery charger and power tool battery pack for adaptive data transfer. A power tool battery pack includes a battery pack housing, battery cells supported by the battery pack housing, and an electronic controller including a processor and a memory. A power tool battery charger may include one or more charging docks, each charging dock including a charging interface for providing charging current, and an electronic controller including a processor and a memory. The electronic controller is configured to determine battery information. The battery information includes one or more of: a battery electrical characteristic, a battery temperature, a replacement battery availability indication, a charging status of a battery pack, or a charge-transfer alternating use indication. The electronic controller is further configured to communicate data at a timing that is based on the battery information.

At least in some embodiments described herein, improved power tool battery chargers, power tool battery packs, systems, and methods are provided that may efficiently and adaptively charge one or more power tool battery packs, and reduce errors and increase efficiency and effectiveness of a power tool battery charger or a power tool battery pack when data is transferred to or from the power tool battery charger or the power tool battery pack.

### BRIEF DESCRIPTION OF THE DRAWINGS

The accompanying drawings, which are incorporated in and form a part of this specification, illustrate embodiments of the disclosure and, together with the description, serve to explain principles of the embodiments:

FIG. 1 is a schematic illustration of a power tool system according to some embodiments.

FIG. 2 is a block diagram of a power tool battery charger according to some embodiments.

FIG. 3 is a block diagram of a power tool battery pack according to some embodiments.

FIG. 4 is a flowchart of a process for charging of one or more power tool battery packs according to some embodiments.

FIG. 5 is a flowchart of a process for charging of multiple power tool battery packs according to some embodiments.

FIG. 6 is a flowchart of a process for data transfer according to some embodiments.

FIG. 7 illustrates examples of waveform using multi-valued signals according to some embodiments.

FIG. 8 is a flowchart of a process for battery pack firmware or battery pack parameter update according to some embodiments.

FIGS. 9A-C illustrate examples of power tool battery pack chargers according to some embodiments.

FIGS. 10A-D illustrate examples of power tool battery packs according to some embodiments.

### DETAILED DESCRIPTION

Some power tools (e.g., cordless power tools) can use battery pack(s) that actuate the power tools without a power cord connected to mains electricity. As power tool technologies advance, the number of power tools using power tool battery packs and the number of power tool battery packs increase. In addition, the environments in which operators use power tools and battery packs, the manner of their use, and the types of power tools and battery packs continues to become more varied. In some scenarios, operators may want to use two or more battery packs for tandem use. In other scenarios, the power tool battery pack may end a particular operation or cease discharging for various reasons (e.g., charge depletion, overheating, task completion, etc.) in advance of charging of the power tool battery packs. In further scenarios, operators may have certain patterns or preferences to charge the power tool battery packs. Charging power tool battery packs without considering these circumstances can decrease battery and charger efficiency and effectiveness, which can lead to faster battery degradation, dissatisfaction of users, among other issues.

Some embodiments described herein provide solutions to these problems (and others) by providing improved power tool battery chargers, systems, and methods for efficiently and adaptively charging power tool battery pack(s) considering various circumstances of the power tool battery pack(s) and the charger. In addition, to consider various circumstances, the power tool battery pack(s) and/or power tool battery charger, in some examples, collect, receive, process, and/or transmit data. Some embodiments described herein also provide solutions to these problems by providing improved systems, power tools, and methods for efficiently and adaptively communicating data at a timing based on certain battery-related information.

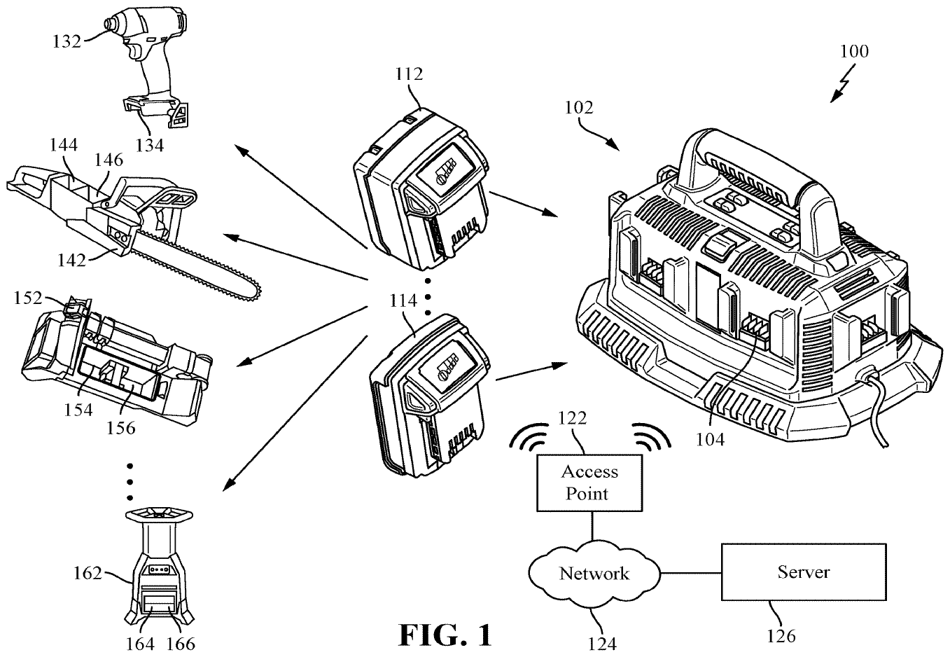

FIG. 1 illustrates a power tool battery charging system 100 according to some embodiments. The power tool battery charging system 100 includes a power tool battery charger 102, power tool battery pack(s) 112, 114, power tool(s) 132, 142, 152, 162, an access point 122, a network 124, and a server 126. The system 100 is illustrated and described with respect to a single power tool battery charger 102: however, in some embodiments, the system 100 is used for additional power tool battery chargers 102.

The battery charger 102 is, for example, a device to provide charging current to one or more battery packs 112, 114. The battery charger 102 may include one or more charging docks 104. Each charging dock 104 is configured to receive and provide charging current to one battery pack 112, 114 at a time. To receive a battery pack 112, 114, the charging dock 104 may electrically and mechanically interface with the battery pack 112, 114. Electrically interfacing may include electrical terminals of the battery pack 112, 114 and the battery charger 102 contacting one another, may include a wireless connection for wireless power transfer (e.g., between inductive or capacitive elements of the pack and the charger), or a combination thereof. Mechanical interfacing may include the power tool pack 112, 114 being received in a receptacle of a dock 104, a mating of physical retention structures of the power tool pack 112, 114 and a dock 104 of the battery charger 102, set on a supporting pad or structure of the dock 104 (e.g., for wireless charging), or a combination thereof. The charger 102 is illustrated as having six docks 104. However, in some examples, the battery charger 102 includes fewer or additional charging docks 104.

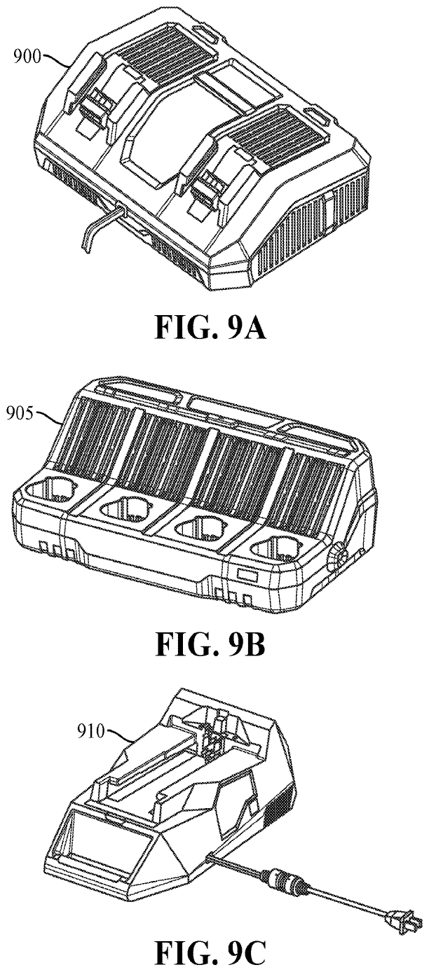

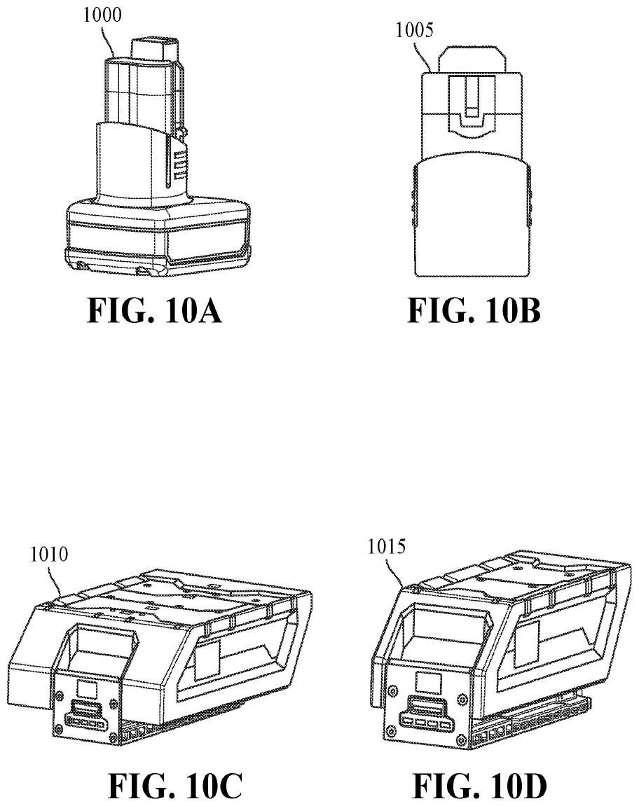

In some examples, a charging dock 104 of the battery charger 102 is configured to receive and charge a battery pack 112, 114. In some aspects, the battery charger 102 may have a different charging dock 104 for a battery pack 112, 114 having a different nominal voltage. For example, a charging dock for a battery pack 112, 114 having a nominal voltage of approximately 18 volts has a different receptacle shape of a charging dock 104 from another charging dock for another battery pack having a nominal voltage of approximately 12 volts or 72 volts. Thus, battery pack 112, 114 having a nominal voltage of approximately 18 volts may not mechanically interface with another charging dock for another battery pack having a nominal voltage of approximately 12 volts or 72 volts. The mechanically incompatible interface can prevent the battery pack 112, 114 from overheating due to excessive charging current, from not being adequately charged due to insufficient charging current, or otherwise not being appropriately charged. In other examples, the battery charger 102 may only have the same charging docks 104 for one type of a battery pack 112, 114. For example, the battery charger 102 may only have one or more charging docks 104 for battery packs having a nominal voltage of approximately 18 volts. Further examples of battery packs and chargers configured according to embodiments described herein are provided with respect to FIGS. 9A-9F and FIGS. 10A-D.

In some aspects of this disclosure, the battery charger 102 may collect data from the battery packs 112, 114 and determine battery information for adaptively charging the battery packs 112, 114. In further aspects, the battery charger 102 may wirelessly communicate with one or more battery packs 112, 114 and/or the server 126 via the access point 122 and the network 124.

The battery pack 112, 114 is, for example, configured to provide power to a power tool 132, 142, 152, 162. The battery pack 112, 114 is further configured to receive charging current and to be charged by the battery charger 102. To be received by the battery charger 102 or power tool 132, 142, 152, 162, the battery pack 112, 114 may electrically and mechanically interface with the battery charger 102 and (at a different time) with a power tool 132, 142, 152, 162. In some examples, the battery pack 112, 114 may have a nominal voltage of approximately 18 volts (between 16 volts and 22 volts), approximately 12 volts (between 8 volts and 16 volts), approximately 72 volts (between 60 volts and 90 volts), or another suitable amount. In some examples, the battery pack 112 having a larger capacity generally provides a longer run time when operating under similar circumstances. To achieve additional capacity, the battery pack 112 may include an additional set of battery cells relative to the pack 114. For example, the battery pack 114 may include a set of series-connected battery cells, while the battery pack 112 may include two or more sets of series-connected battery cells, with each set being connected in parallel to the other set(s) of cells.

In some aspects of this disclosure, the battery pack 112, 114 may collect data about the battery pack 112, 114 and/or about a power tool coupled to and powered by the battery pack 112, 114, and/or store the data in a memory of the battery pack 112, 114. In further aspects, the battery pack 112, 114 may communicate with one or more battery charger 102 while the battery pack 112, 114 is electrically and mechanically connected in a charging dock 104 of the battery charger 102. In even further aspects, the battery pack 112, 114 may wirelessly communicate with one or more battery chargers 102 and/or the server 126 via the access point 122 and the network 124.

The power tool 132, 142, 152, 162 may be, for example, a motorized power tool 132, 142 (e.g., an impact driver, a power drill, a hammer drill, a pipe cutter, a sander, a nailer, or a grease gun) or a nonmotorized power tool 152, 162 (e.g., a worksite radio or worksite light). The power tool 132, 142, 152, 152 may have a battery receptacle for electrically and mechanically interfacing with the battery packs 112, 114. Some power tools 132 may, for example, have one battery receptacle 134 receiving one battery pack 112, 114.

Other power tools 142, 152 may, for example, have two or more battery receptacles 144, 146, 154, 156 and use two or more battery packs 112, 114 in tandem to generate more power or provide a longer runtime. In some scenarios, some non-motorized 152 or motorized power tools 142 (e.g., a chainsaw; a lawn mower, etc.) may operate with a higher voltage (e.g., 36 volts) to generate more power or torque than other power tools (e.g., an impact driver that operates at 18 volts, etc.). To generate more power, the power tools 142, 152 may connect two or more battery packs 112, 114 in series (e.g., two 18-volt packs connected in series). In other scenarios, some motorized or non-motorized power tools 152 (e.g., a power tower light, etc.) may have two or more battery receptacles 154, 156 to use two or more battery packs 112, 114 in tandem to provide a longer operating time. The power tools 152 may connect two or more battery packs 112, 114 in parallel to increase the coulometric or nominal capacity of the two or more battery packs 112, 114. Thus, the connected battery packs 112, 114 may provide a longer run time of the power tools 152 from a given maximum charge target (e.g., 100% or 80% state of charge (SoC)) to the cut-off voltage of the battery packs 112, 114. In further scenarios, some motorized or non-motorized power tools 162 (e.g., a site light, etc.) may have two or more battery receptacles 164, 166, but may be capable of running off of some or all of the two or more battery packs 112, 114 received by the two or more battery receptacles 164, 166. It should be appreciated that these power tools with battery receptacle configurations are mere examples and any other suitable battery receptacle configuration may be employed. For example, some power tools may have two or more receptacles for battery packs having different nominal voltages (e.g. to provide a certain power level and/or a longer runtime using combination of the battery packs having different nominal voltages).

The access point 122 is, for example, a mobile device (e.g., a smart phone, a tablet, or laptop), a Wi-Fi router, a cellular tower, or another wireless communication device. The access point 122 provides wireless access to the network 124 for other components of the system 100, including one or more of the battery charger 102 and/or the battery pack 112, 114. Accordingly, the battery charger 102 and/or the battery pack 112, 114 may communicate with the server 110 via the network 124 and a wireless connection to the access point 122. The battery charger 102 and/or the battery pack 112, 114 may communicate with the access point 122 wirelessly using one or more of the Bluetooth® protocol, Wi-Fi protocol, cellular protocol, or the like.

The network 124 includes, for example, one or more of a local area network (LAN) (e.g., a Wi-Fi network), a wide area network (WAN) (e.g., a cellular network or the Internet), or another communication network configuration. The network 124 may include one or more network nodes. A network node may include a router, hub, a personal computer, a server, a host, or any other suitable device to provide network resources. The network 124 provides a connection between the server 126 and other devices in the system 100. For example, the battery charger 102 and/or the battery pack 112, 114 may communicate with the server 126 via the network 124. Similarly, the access point 122 may communicate with the server 110 via the network 124.

The server 126 includes, for example, an electronic server processor and a server memory. Although illustrated as a single device, the server 126 may be a distributed device in which the server processor and server memory are distributed among two or more units that are communicatively coupled (e.g., via the network 124). The server 126 may maintain a database for the system (e.g., on the server memory). The server 126 may store data related tool battery chargers 102 and/or battery packs 112, 114, including battery information. The server 110 may receive the data for adaptively charging the battery pack 112, 114 from the battery pack 112, 114 and/or the battery charger 102. For example, the battery pack 112, 114 and/or the battery charger 102 may periodically or occasionally communicate one or more types of the data with the server 110 via the access point 122 and/or network 124.

The particular numbers, types, and locations of components with the system 100 of FIG. 1 are merely used as an example for discussion purposes: additional and/or different types of battery chargers 102, battery packs 112, 114, power tools 132, 142, 152, 162, access points 122, networks 124, and servers 126 may be present in some embodiments of the system 100.

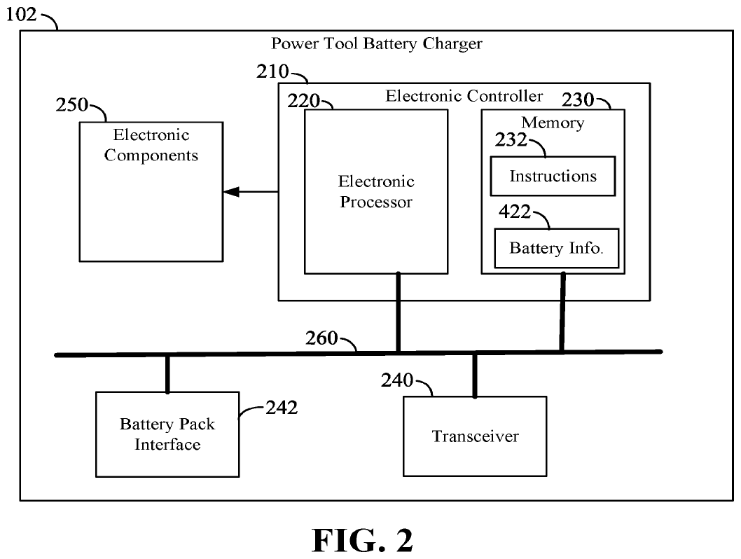

FIG. 2 is a block diagram of a power tool battery charger 102. In some examples, the battery charger 102 may include a charger electronic controller 210, a battery pack interface 242, a transceiver 240, and/or electronic components 250. The charger electronic controller 210 may include an electronic processor 220 and a memory 230. The electronic processor 220, the memory 230, and the transceiver 240 may communicate over one or more control and/or data buses (for example, a device communication bus 260). The memory 230 may include read-only memory (ROM), random access memory (RAM), other non-transitory computer-readable media, or a combination thereof. The memory 230 may include instructions 232 for the electronic processor 220 to execute.

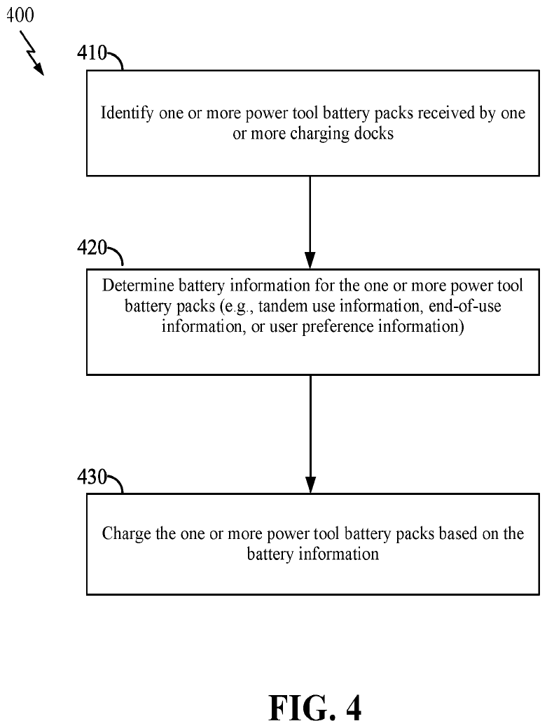

The electronic processor 220 may be configured to communicate with the memory 230 to store data and retrieve stored data. The electronic processor 220 may be configured to receive the instructions 232 and data from the memory 230 and execute, among other things, the instructions 232. In some examples, through execution of the instructions 232 by the electronic processor 220, the charger electronic controller 210 may perform one or more of the methods described herein. For example, the instructions 232 may include software executable by the electronic processor 220 to enable the charger electronic controller 210 to, among other things, implement the various functions of the charger electronic controller 210 described herein, including the functions of the charger electronic controller 210 described with respect to processes 400, 500, 600, and/or 800 of FIGS. 4-6 and/or 8.

The battery pack interface 242 may be configured to provide charging current to the battery pack 112, 114 received in a charging dock 104 and communicate with the battery pack 112, 114. The battery pack interface 242 may include one or more power terminals to provide charging current to the battery pack 112, 114 and, in some cases, one or more communication terminals to communicate with the battery pack 112, 114. The one or more power terminals and the one or more communication terminals of the battery charger 102 may be configured to be electrically and physically connect to corresponding one or more power terminals and one or more communication terminals of the battery pack 112, 114, respectively. In some examples, the electronic processor 220 may probe the battery pack 112, 114 via the battery pack interface 242 and collect data for adaptively charging the battery pack 112, 114 and adaptively communicating data with the battery pack 112, 114. In embodiments of the charger 102 having a single charging dock 104, the battery pack interface 242 may include a single interface for interfacing with a single battery pack 112, 114. In embodiments of the charger 102 having a plurality of charging docks 104, the battery pack interface 242 may include a plurality of interfaces, one for each charging dock 104, such that the charger 102 can interface with a plurality of battery packs 112, 114.

In some examples, the battery pack interface 242 may include a physical lock (e.g., using a solenoid locking mechanism or any suitable electromagnetic lock) for the charger electronic controller 210 to lock and prevent the battery pack 112, 114 from being removed from the battery charger 102. For example, the electronic controller 210 may provide a lock signal to the solenoid locking mechanism, which may actuate a solenoid to extend or move a lock element (e.g., a pin, bar, bolt, shackle, etc.) into or through a lock receptacle on the charger 102 (preventing removal of the battery pack), and may provide an unlock signal to de-actuate the solenoid to retract or move the lock element out or away from the lock receptacle on the charger 102 (permitting removal of the battery pack).

In some embodiments, the battery charger 102 may optionally include a transceiver 240). The transceiver 240 may be communicatively coupled to the charger electronic controller 210 (e.g., via the bus 260) for transmitting and receiving radio waves using an antenna. The transceiver 240 enables the charger electronic controller 210 (and, thus, the power tool battery charger 102) to communicate with other devices (e.g., a battery pack 112, 114, a server 126, an access point 122, and/or other power tool devices 132, 142, 152, 162). In other examples, the battery charger 102 does not include the transceiver 240. Rather, the battery charger 102 may, in some examples, include a network connector (e.g., a Local Area Network (LAN) connector, etc.) configured to be connected to the network 124 (e.g., the internet) by using a physical cable (e.g., an Ethernet cable, etc.). Thus, the battery charger 102 may communicate with other devices (e.g., a server 126) via the terrestrial network using wired communications.

In some embodiments, the battery charger 102 also includes additional electronic components 250. In some examples, the electronic component 250 may include a motion sensor to detect movement of the battery pack 112, 114. The motion sensor may include a force sensor to measure the manner in which the battery pack 112, 114 is received in the charging dock 104. The force sensor may include pneumatic a load cell (e.g., a pneumatic load cell, a hydraulic load cell, a piezoelectric crystal load cell, an inductive load cell, a capacitive load cell, a magnetostrictive load cell, strain gage load cell, etc.), a strain gage, a force sensing resister, or any other suitable force sensor to measure a force to the charging dock 104 when the battery pack 112, 114 is received to the charging dock 104. Also, the electronic component 250 may further include a temperature-measurement sensor to measure the temperature of the battery charger 102 (e.g., inside a housing of the charger 102 or of circuit elements (e.g., power switching elements) of the charger 102), of an environment outside of the battery charger 102 (e.g., ambient temperature), and/or the battery pack 112, 114 (e.g., at an exterior surface of the battery pack 112, 114 or at terminals of the battery pack 112, 114). The temperature sensor may output temperature data indicating the measured temperature to the electronic controller 210.

In some examples, the electronic component 250 may further include a charging mode button to select a fast charge mode and a normal charge mode for the battery pack 112, 114 configured to be received in the charging dock 104. The fast charge mode is configured to charge the battery pack 112, 114 faster than the normal charge mode by increasing the charging power, charging current, or charging voltage. In some examples, since the fast charge mode might increase the temperature of the battery charger 102, some battery chargers may also include a cooling fan to prevent the charger 102 from overheating. It should be understood that the charging mode button may not be limited to a button. The fast charge mode and the normal charge mode may be selected using a switch, a touch sensor, a software program installed in an operator's mobile device that is in communication with the charger 102, or any other suitable controller to change the charging mode for a battery pack configured to be received in a respective charging dock that correspond to the charging mode.

In some examples, the electronic component 250 may further include a priority button to charge with a higher priority the battery pack 112, 114 configured to be received in the charging dock 104. Here, charging a battery pack with a higher priority may, for example, indicate that the charger electronic controller 210 stops conveying charging current to other battery packs except the battery pack having the higher priority. In other examples, charging a battery pack with the higher priority may also indicate that the charger electronic controller 210 may charge the battery pack with high charging power or high charging current while other battery packs without the higher priority may be charged with low charging power or low charging current. In further examples, the priority button may support several levels of priority and charge the battery pack according to a level of the priority. It should be understood that the priority button may not be limited to a button. The priority may be set using a switch, a touch sensor, a software program installed in an operator's mobile device that is in communication with the charger 102, or any other suitable controller to set the priority of a battery pack configured to be received in a respective charging dock that correspond to the priority.

In further examples, the electronic component 250 may further include a radio-frequency identification (RFID) reader to read a battery identification number stored on an RFID tag in or on the battery pack 112, 114

The power tool battery charger 102 may further include charging circuitry, for example, as part of the electronic components 250. The charging circuitry may receive power (e.g., from an external AC source or DC source via a power interface of the charger 102), condition the received power to produce conditioned power (e.g., rectify AC power to DC power, convert DC power to desired voltage level, filter out current or voltage spikes, etc.), and selectively apply charging current to one or more of the charging docks 104 via the battery pack interface 242. For example, the charging circuitry may include one or more power switching elements (e.g., field effect transistors (FETs) or bipolar junction transistor (BJTs)) that are selectively controlled by the electronic controller 210 to be enabled or disabled to provided the conditioned power to the charging docks 104. For example, each charging dock may be associated with a respective one (or more) power switching elements that makes or breaks (based on control signal from the electronic controller 210) a circuit connection to the conditioned power. Various examples of control logic implemented by the electronic controller 210 for generating such control signals and charging one or more battery packs coupled to the charging docks 104 are provided herein (e.g., with respect to FIGS. 4-8).

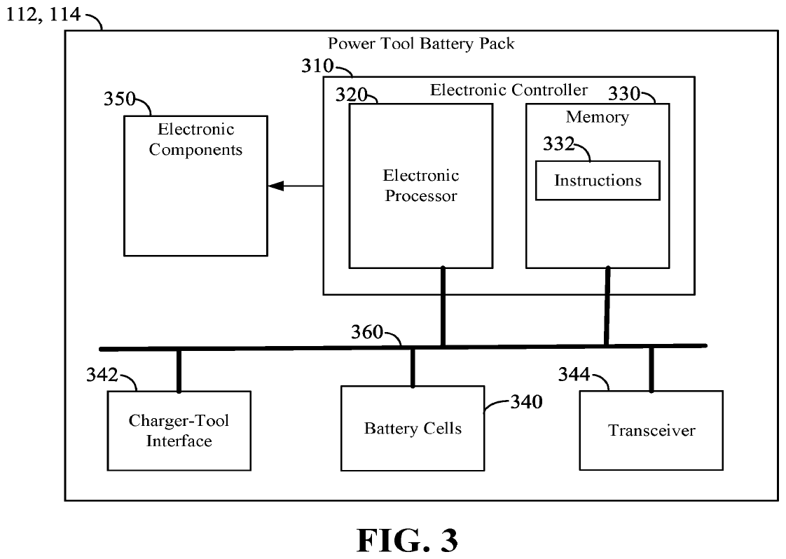

FIG. 3 is a block diagram of an example of a power tool battery pack 112, 114. In some examples, the battery pack 112, 114 may include a battery electronic controller 310, battery cells 340, a charger and tool interface 342, a transceiver 344, and/or electronic components 350. The battery electronic controller 310 may be substantially the same as the charger electronic controller 210 of the battery charger 102 illustrated in FIG. 2. That is, the battery electronic controller 310, as utilized in the battery pack 112, 114, may be configured (e.g., in coordination with instructions 332 in the memory 330) to implement any one or more of the functions described below and illustrated in FIGS. 4-8.

The battery cells 340 are configured to receive charging current from the battery charger 102 via the charger and tool interface 342 and store the power from the charger 102 in the battery cells 340. In addition, the battery cells 340 are configured to convey operational power (e.g., voltage and current) to the power tool 132, 142, 152, 162 connected to the battery pack 112, 114 via the charger and tool interface 342. The battery cells 340 may have various chemistries, such as lithium-ion (Li-Ion), nickel cadmium (Ni-Cad), and the like. Each battery cell has a nominal voltage (e.g., 3.6 volts). A battery pack 112, 114 may include a set of series-connected battery cells. The sum of nominal voltages of the series-connected battery cells may be the nominal voltage of the battery pack 112, 114. In some examples, the battery pack 340 in combination the series-connected battery cells 340 may have a nominal voltage of approximately 12 volts, 18 volts, 72 volts, or any other suitable nominal voltage depending on the number of the series-connected battery cells 340. In some examples, the battery cells 340 also have a capacity of approximately 1 ampere-hours (Ah) to 8 Ah. For example, multiple sets of the series-connected battery cells 340 may be connected in parallel to have a larger capacity than one set of the series-connected battery cells 340, while these multiple sets of the series-connected battery cells 340 have the same nominal voltage as one set of the series-connected battery cells 340.

The charger and tool interface 342, also referred to as the charger interface 342 or the tool interface 342 herein for simplicity, may include one or more power terminals to receive charging current from the battery charger 102 and provide power to the power tool 132, 142, 152, 162. In some cases, the charger interface 342 may include one or more communication terminals to communicate with the battery charger 102 and/or the power tool 132, 142, 152, 162. The functions of the terminals may be substantially the same as those in the battery charger 102 illustrated in FIG. 2. In some examples, to firmly secure the electrical and mechanical connection between the interfaces 242, 342 of the battery charger 102 and the battery pack 112, 114, the battery pack 244 may further selectively latch and unlatch (e.g., with a spring-biased latching mechanism) to the battery charger and/or the power tool device 132, 142, 152, 162. In some examples, the electronic processor 320 may provide battery information or collected data to the battery charger 102 via the charger interface 342. In some examples, the charger interface 342 may include a physical lock (e.g., using a solenoid locking mechanism or any suitable electromagnetic lock) for the battery electronic controller 310 to lock and prevent the battery pack 112, 114 from being removed from the battery charger 102. For example, the electronic controller 310 may provide a lock signal to the solenoid locking mechanism, which may actuate a solenoid to extend or move a lock element (e.g., a pin, bar, bolt, shackle, etc.) into or through a lock receptacle on the battery pack 112, 114 or removal pathway for the battery pack 112, 114 (preventing removal of the battery pack), and may provide an unlock signal to de-actuate the solenoid to retract or move the lock element to permit removal of the battery pack.

In some embodiments, the battery pack 112, 114 may also optionally include the transceiver 344 to wirelessly communicate with one or more battery charger 102 and/or the server 126 via the access point 122 and the network 124. In other examples, the battery pack 112, 114 does not have the transceiver 344. Rather the battery pack 112, 114 may communicate with one or more battery charger 102 via the charger interface 342 while the battery pack 112, 114 is electrically and physically connected to the battery charger 102.

In some embodiments, the battery pack 112, 114 also includes additional electronic components 350. In some examples, the electronic component 350 may include a temperature sensor. The temperature sensor may be configured to measure the temperature of the battery cells 340, the temperature of an environment outside of the battery pack 112, 114 (e.g., ambient temperature), and/or of other circuit elements of the battery pack 112, 114 (e.g., power switching elements). The temperature sensor may output temperature data indicating the measured temperature (e.g., the battery cell temperature or ambient temperature) to the battery electronic controller 310. The additional electronic components 350 may further include a motion sensor. The motion sensor may include an accelerometer, gyrometer, gyroscope, or magnetometer to measure the rate of change of velocity over time or vibrations or orientation with respect to gravity. The motion sensor may output acceleration data to the battery electronic controller 310. The acceleration data may include an indication of the measured acceleration experienced by the motion sensor and, thus, by the battery pack 112, 114. However, it should be appreciated that the motion sensor may detect other motion. For example, the motion sensor may include a position sensor (e.g., a gyrometer, a gyroscope, or a magnetometer). The motion sensor may output its position data (e.g., an orientation, an angular velocity, and/or a direction a relative change of magnetic field at a location) to determine its location and, thus, the location of the battery pack 112, 114.

In further examples, the electronic component 250 may include an RFID tag including a battery identification number that is distinguishable from another battery pack.

FIG. 4 illustrates a process 400 for adaptive charging of one or more battery packs 112, 114. The process 400 is described below as being carried out by the battery charger 102 of the system 100 as illustrated in FIGS. 1 and 2. For example, the blocks of the process 400 below are described as being executed by the charger electronic controller 210 of the battery charger 102. However, in some embodiments, the process 400 is implemented by another device and/or in another system having additional, fewer, and/or alternative components (see, e.g., chargers illustrated in FIGS. 9A-C). Additionally, although the process is described with respect to one or more battery packs 112,114, the process may be implemented by a charger configured to charge other types of battery packs (see, e.g., battery packs illustrated in FIGS. 10A-10D). Additionally, although the blocks of the process 400 are illustrated in a particular order, in some embodiments, one or more of the blocks may be executed partially or entirely in parallel, may be executed in a different order than illustrated in FIG. 4, or may be bypassed.

In block 410, the charger electronic controller 210 identifies one or more battery packs 112, 114 received by one or more charging docks 104. In some examples, the charger electronic controller 210 may identify an individual battery pack 112, 114. For example, each battery pack 112, 114 may have its own identification number in its memory 330, on its physical housing, or in a radio-frequency (RF) tag (e.g., radio-frequency identification (RFID) tag. Near Field Communication (NFC) tag, or any other suitable RF tag) included in the respective battery pack 112, 114. Here, the identification number may include a series of numerical, alphabetical, or alphanumerical digits differently assigned to each battery pack. Thus, each battery pack 112 has its unique and specific identification number distinguishable from another battery pack 114. The charger electronic controller 210 of the battery charger 102 may, then, obtain each battery pack identification number by accessing the memory 330 of the respective battery pack 112, 114, scanning the identification number of the respective battery pack 112, 114, or reading the RFID tag of the respective battery pack 112, 114 using an RFID reader included in the battery charger 102. It should be appreciated that the above-described examples to identify a battery pack 112, 114 are not limited. The battery charger 102 may employ any other suitable technique to identify a battery pack 112, 114.

In some examples, the charger electronic controller 210 may identify the packs 112,114 by identifying the type of the battery pack 112, 114 received by the charging dock 104. For example, the charger electronic controller 210 might identify the battery pack 112, 114 having a nominal voltage of approximately 12 volts, 18 volts, or 72 volts. In some examples, the types of the battery pack may be identifiable based on the physical shape of the interface of the battery pack 112, 114 where the each type of battery pack 112, 114 may have a different shape of the interface of the battery pack 112, 114 to be received in a respective charging dock 104 of the battery charger 102. Thus, in the examples, the charger electronic controller 210 can identify the type of the battery pack 112, 114 when the charging dock 104 receives the battery pack 112, 114. In other examples, the types of the battery pack may be identifiable based on the measurement of the output power, voltage, current, and/or internal resistance of the battery pack 112, 114. For example, when the battery pack 112, 114 is received by the charging dock 104 of the battery charger 102, the charger electronic controller 210 may first measure the output power, voltage, current, and/or internal resistance of the battery pack 112, 114 before charging or communicating with the battery pack 112, 114. Then, the charger electronic controller 210 may determine the type of the battery pack 112, 114 based on the measurement.

The charger electronic controller 210 of the battery charger 102 may, for example, identify the one or more battery packs 112, 114 by recognizing or detecting that with the battery packs 112, 114 have interfaced with the interface 342 of the battery pack charger 102. In some examples, the battery charger 102 does not need to be physically connected to the battery pack 112, 114 to identify the one or more battery packs 112,114. For example, the battery charger 102 may communicate with the battery pack 112, 114 via the transceivers 240, 344 of the battery charger 102 and the battery pack 112, 114 using a suitable wireless communication protocol (e.g., a Bluetooth protocol, Wi-Fi protocol, NFC, cellular protocol, etc.). In the examples, the battery charger 102 may communicate with the battery pack 112, 114, and at the same time or at a different time provide charging current to the battery pack 112, 114.

In some examples, the charger electronic controller 210 may identify two or more battery packs 112, 114 received in two or more corresponding charging docks 104. In some examples, the charger electronic controller 210 may identify each battery pack 112, 114 of the two or more battery packs 112, 114 as described above.

In blocks 420 and 430, the charger electronic controller 210 may determine battery information for the one or more battery packs 112, 114 and charge the one or more battery packs based on the battery information. The battery information may be stored in the memory 230 as battery information 422 (e.g., after being determined by the charger electronic controller 210). The battery information may indicate one or more of: 1) tandem use information for the one or more battery packs 112, 114, 2) end-of-use information for the one or more battery packs, or 3) user preference information for the one or more battery packs 112, 114. In some examples, the battery information may further include power tool information. The power tool information may be a basic power tool information (e.g., power tool product identification number, etc.), power tool usage statistics (e.g., running time, running hours, temperatures, etc.), raw sensor data, metadata, or any other suitable power tool information that can be gathered from the power tool. Since battery charging behavior of the battery charger 102 in block 430 may vary based on the type of battery information determined in block 420, blocks 420 and 430 are explained together in respective sections below for each type of the battery information.

### 1. Tandem Use Information

In block 420, the charger electronic controller 210 may determine the battery information that indicates the tandem use information for the one or more battery packs 112, 114. Returning to FIG. 1, some power tools 142, 152 may use two or more battery packs in tandem to generate more power and/or provide a longer runtime than one battery pack 112, 114. For the battery tandem use, the one or more battery packs 112, 114 may be two or more battery packs 112, 114 being used together for a power tool 142, 152. Here, the tandem use information may, for example, indicate one or more of: 1) the two or more battery packs are intended to be used on a power tool in tandem or 2) the two or more battery packs 112, 114 have been used on a power tool in tandem.

### 1) Battery Information Determination Based on Tandem Use Intent

In some examples, the charger electronic controller 210 may indicate that the two or more battery packs are intended to use on a power tool in tandem by determining one or more conditions. The conditions may include one or more of: 1) the two or more battery packs 112, 114 are received by the battery charger 102 at substantially a same time, 2) the two or more battery packs 112, 114 have substantially equal voltage levels when the two or more battery packs 112, 114 are received by the battery charger 102, 3) the two or more battery packs 112, 114 have substantially equal capacities, 4) the electronic controller received an indication from the two or more battery packs 112, 114 that the two or more battery packs 112, 114 are to be used in tandem, 5) the charger electronic controller 210 received a request via a user interface that the two or more battery packs 112, 114 are to be used in tandem, or 6) a power tool 132, 142, 152, 162 within a communication range is configured to use battery packs 112, 114 in tandem. The conditions are not exclusive, but any other suitable conditions to indicate the tandem use of the two or more battery packs 112, 114 received in the battery charger 102 may be included. In some examples, the charger electronic controller 210 may determine a condition among the various conditions described above by identifying that the condition happens. In some examples, the charger electronic controller 210 may determine the battery information indicating the tandem use information when each condition is assigned to one or a weight, and the number of the determined conditions or the sum of the weights of corresponding conditions is more than a predetermined threshold. For example, when there are 6 conditions to indicate the tandem use information, the charger electronic controller 210 may determine the conditions with/without corresponding weights as shown in Table 1:

TABLE 1

| Condition No. | Determination | Weight | Weighted Determination |
|---|---|---|---|
| Condition 1 | 1 | 2 | 2 |
| Condition 2 | 0 | 1 | 0 |
| Condition 3 | 1 | 1 | 1 |
| Condition 4 | 0 | 3 | 0 |
| Condition 5 | 0 | 4 | 0 |
| Condition 6 | 1 | 1 | 1 |
| Sum | 3 | | 4 |

* Threshold = 2 (5 with weights)

In some examples shown in Table 1, the charger electronic controller 210 determines that conditions 1, 3, and 6 are true (1) and conditions 2, 4, and 5 are not true (0). When each condition does not have any weight and a predetermined threshold is two, the charger electronic controller 210 determines that the two or more battery packs 112, 114 are intended for tandem use when three or more conditions are evaluated as true. Thus, the charger electronic controller 210 may determine that the battery information indicates the tandem use information indicating that the two or more battery packs 112, 114 are intended for use on a power tool in tandem. In other examples, each condition may have a weight. That is, some conditions (e.g., a request via a user interface that the battery packs are to be used in tandem, etc.) may signify the intention to use the battery packs in tandem more than other conditions (e.g., substantial equal capacities of the battery packs, etc.). Thus, in the examples shown in Table 1, the weighted sum of determinations is 4 (2 (condition 1 with weight 2)+1 (condition 3 with weight 1)+1 (condition 6 with weight 1)=4) that is not more than the predetermined threshold (5) for the weighted sum. Thus, the charger electronic controller 210 may determine that the battery information does not indicate the tandem use information indicating that the two or more battery packs 112, 114 are intended for use on a power tool in tandem. Of course, the particular weights and predetermined thresholds are used merely for illustration and discussion purposes. The particular weights and predetermined threshold may be any other suitable values determined by implementation. Each condition is further explained below.

Condition 1: The charger electronic controller 210 may determine that the two or more battery packs 112, 114 are received by the battery charger 102 at substantially the same time. Here, substantially the same time may indicate within a predetermined period of time (e.g., 1 second, 10 seconds, 30 seconds, 1 minute, or any other suitable time period). For example, when a tool uses the two or more battery packs 112, 114 in tandem, an operator of the tool may place the two or more battery packs 112, 114 in the battery charger 102 within a predetermined period of time (e.g., 30 seconds or any other suitable time period) for charging. In some examples, when a plurality of battery packs 112, 114 are received in the battery charger 102, the charger electronic controller 210 may record the time for each battery pack 112, 114 received by the battery charger 102. Then, the charger electronic controller 210 may calculate the time period between every set of two consecutively received battery packs 112, 114. The charger electronic controller 210 may determine that the two consecutively received battery packs 112 114 are received by the battery charger 102 at substantially the same time when each set of two consecutive battery packs is received within less than the predetermined period of time. This may apply to more than two battery packs when all two consecutive battery packs of two or more battery packs 112, 114 are received within the predetermined period of time. For example, when the predetermined period of time is 5 minutes and six battery packs (battery pack 1, 2, 3, 4, 5, and 6) are received by the battery charger 102 at 11:00, 11:02, 11:04, 11:08, 12:00, and 12:10, respectively. Then, the charger electronic controller 210 may determine that battery packs 1, 2, 3, and 4 are received by the battery charger 102 at substantially the same time because each of three sets of two consecutive battery packs (battery packs 1 and 2; battery packs 2 and 3; and battery packs 3 and 4) is received by the battery charger 102 within the predetermined period of time (5 minutes). Based on this condition, with or without other conditions, the charger electronic controller 210 may determine the tandem use information for battery packs 1, 2, 3, and 4, indicating that battery packs 1, 2, 3, and 4 are intended for use on a power tool in tandem.

Condition 2: The charger electronic controller 210 may determine that the two or more battery packs 112, 114 have substantially equal voltage levels when the two or more battery packs 112, 114 are received by the battery charger 102. Here, the substantially equal voltage levels may indicate within a predetermined voltage difference between the two or more battery packs 112, 114 (e.g., within 0.5% voltage difference, within 1% voltage difference, within 1 volt difference, or within any other suitable voltage difference to be considered substantially equal). In some examples, when the two or more battery packs 112, 114 are received by the battery charger 102, the charger electronic controller 210 may measure open-circuit voltages of the two or more corresponding battery packs 112, 114. Then, the charger electronic controller 210 may calculate the voltage difference of two or more battery packs 112, 114, the charger electronic controller 210 may determine that the two or more battery packs 112, 114 received by the battery charger 102 have substantially equal voltage levels when the voltage difference of the two or more battery packs 112, 114 is less than a predetermined voltage difference. For example, when the predetermined voltage difference is 0.5 volt and six battery packs (battery pack 1, 2, 3, 4, 5, and 6) received by the battery charger 102 have 16.2 volts, 16.3 volts, 16.4 volts, 16.5, 17.4 volts, and 18.2 volts, respectively. Then, the charger electronic controller 210 may determine that battery packs 1, 2, 3, and 4 have substantially equal voltages because the voltage difference among battery packs 1, 2, 3, and 4 is less than the predetermined voltage difference (0.5 volt). Based on this condition, with or without other conditions, the charger electronic controller 210 may determine the tandem use information for battery packs 1, 2, 3, and 4, indicating that battery packs 1, 2, 3, and 4 are intended for use on a power tool in tandem. It should be appreciated that measuring the open-circuit voltage is a mere example. The charger electronic controller 210 might use any other suitable measurement to determine the substantially equal voltage. In some examples, the charger electronic controller 210 may measure terminal voltages of the two or more corresponding battery packs 112, 114 to determine the substantially equal voltage.

Condition 3: The charger electronic controller 210 may determine that the two or more battery packs 112, 114 have substantially equal capacities. Here, the capacity may indicate the total ampere hours (Ah) that is the amount of current the respective battery pack can supply for one hour. For example, each battery pack 112, 114 may include information about its capacity indicating in the memory 330. The charger electronic controller 210 of the battery charger 102 may obtain the information by accessing the memory 330 of the respective battery pack 112, 114. Then, the charger electronic controller 210 may determine the substantially equal capacity of the two or more battery packs 112, 114. In further examples, each battery pack 112, 114 may include the information about its capacity in the identification number of the respective battery pack. Thus, the charger electronic controller 210 of the battery charger 102 may obtain the information by scanning the identification number of the two or more battery packs 112, 114 or reading the RF tags (e.g., RFID tags or NFC tags) in the two or more battery packs 112, 114. Then, the charger electronic controller 210 may determine the substantially equal voltage when the capacities of the two or more battery packs are equal. In other examples, the capacity may indicate an available battery capacity or a state of charge of the battery pack 112, 114. For example, the charger electronic controller 210 may determine the substantially equal capacities (e.g., substantially equal states of charge) by measuring voltages, currents, internal resistance, or the combination of measurements. In further examples, the capacity may indicate the battery capacity or quantity of charge that has been used since a last charge received from the battery charger 102 or since a full charge. Based on this condition with or without other conditions, the charger electronic controller 210 may determine the tandem use information for the two or more battery packs, indicating that the two or more battery packs are intended for use on a power tool in tandem.

Condition 4: The charger electronic controller 210 may determine that the charger electronic controller 210 received an indication from the two or more battery packs 112, 114 that the two or more battery packs 112, 114 are to be used in tandem. For example, each battery pack may include, in the memory 330, an indication that the respective battery pack is to be used in tandem. The indication may be stored at the time of manufacture or by way of a communication from a mobile device in response to an input received at a graphical user interface (GUI) of the mobile device by a user. When the two more battery packs 112, 114 are received in the battery charger 102, the charger electronic controller 210 of the battery charger 102 may receive the indication by accessing the memory of each battery pack 112, 114. Then, based on the information in the memories 330 of the two or more battery packs 112, 114, the charger electronic controller 210 may determine that the charger electronic controller 210 received an indication from the two or more battery packs 112, 114 that the two or more battery packs 112, 114 are to be used in tandem. In other examples, some battery packs 112, 114 may produce an improved result (e.g., improved efficiency or maximum output power) when used in tandem and have identification number including the indication that the battery packs are to be used in tandem. Then, the charger electronic controller 210 of the battery charger 102 may obtain the indication by scanning the identification number of the battery packs 112, 114 or reading the RFID tags in the two or more battery packs 112, 114. Based on this condition with or without other conditions, the charger electronic controller 210 may determine the tandem use information for the two or more battery packs 112, 114, indicating that the two or more battery packs are intended for use on a power tool in tandem.

Condition 5: The charger electronic controller 210 may determine that the charger electronic controller 210 received a request via a user interface that the two or more battery packs 112, 114 are to be used in tandem. That is, the user of the battery charger 102 may directly request that the two or more battery packs 112, 114 are to be used in tandem via a user interface. The user interface may include a button on the battery charger 102, a software application on a mobile device wirelessly connected to the battery charger 102, or any other suitable technique to request the battery packs' tandem use. For example, the button on the battery charger 102 may correspond to a charging dock. When the button is turned on, it may indicate that a battery pack received in the charging dock is intended for tandem use. Thus, the charger electronic controller 210 determines battery packs 112, 114 with corresponding buttons that are turned on are to be used in tandem. In some aspects, there is just one button on the battery charger 102 (e.g., linked to multiple or all charging docks). For example, the charger electronic controller 210 may determine that all battery packs in the battery charger 102 are to be used in tandem or determine with other conditions some battery packs 112, 114 are to be used in tandem. In some examples, the button may include a switch or any other suitable device and/or controller to indicate battery pack(s) received in the charging dock is intended for tandem use. In other examples, the battery charger 102 may have charging docks for tandem use, physically separated from other charging docks. In other scenarios, the charging docks for tandem use may be adjacent, grouped or paired with each other, or otherwise labeled or identifiable as docks for charging batteries to be used in tandem. In some scenarios, battery packs 112, 114 for tandem use may also utilize a special mating mechanism only to be suited for the charging docks for tandem use. Then, other battery packs 112, 114 for non-tandem use may be configured to not fit properly into the charging docks for tandem use.

In other instances, the user interface may be on a GUI of a mobile device executing a software application wirelessly connected to the battery charger 102. For example, the battery charger 102 may be connected to the network 124 (e.g., via the access point 122 with the transceiver 240), and a mobile device connected to the network 124 may have and execute a software application to communicate with the battery charger 102. The software application may transmit a request that the two or more battery packs 112, 114 are to be used in tandem. The battery charger 102 may receive the request (e.g., via the transceiver 240) and determine that the two or more battery packs 112, 114 are to be used in tandem. In some examples, the software application may indicate specific two or more battery packs 112, 114 in the battery charger 102 for the tandem use. In other examples, the software application may indicate the number of battery packs 112, 114 in the battery charger 102 for the tandem use. In further examples, the software application may indicate all battery packs 112, 114 in the battery charger 102 for the tandem use by transmitting a one-bit request to the battery charger 102. It should be understood that the battery charger 102 may receive the request via any other suitable method. Based on this condition with or without other conditions, the charger electronic controller 210 may determine the tandem use information for the two or more battery packs 112, 114, indicating that the two or more battery packs are intended for use on a power tool in tandem.

Condition 6: The charger electronic controller 210 determines that a power tool 132, 142, 152, 162 within a communication range is configured to use battery packs 112, 114 in tandem. For example, the battery charger 102 may be connected to the network 124 via an access point 122 (e.g., a Wi-Fi router, a mobile device, etc.). Different access points may cover different ranges of communication. For example, a Wi-Fi router generally reaches up to 100 meters while a mobile device (e.g., using the Bluetooth® protocol) generally covers approximately 10 meters. When the access point 122 is the Wi-Fi router, the power tool to use battery packs in tandem is generally within communication range when within 100 meters from the battery charger 102, while the power tool is generally within communication range when within 10 meters with the same mobile device as the battery charger 102. In some examples, the charger electronic controller 210 may identify a power tool configured to use battery packs 112, 114 in tandem from the same access point 122. For example, the access point 122 may have a lookup table mapped to power tools currently connected to the access point 122. The lookup table mapped to connected power tools may be stored in a shared memory space that the charger electronic controller 210 can access. In some scenarios, the lookup table may also indicate tandem use information indicating that the respective power tool supports using battery packs 112, 114 in tandem. In other scenarios, the memory 230 of the battery charger 102, rather than the access point 122, may include a lookup table indicating the tandem use information indicating that the indexed power tool supports using battery packs in tandem. Thus, the charger electronic controller 210 may obtain a list of connected power tools 132, 142, 152, 162 and identify a power tool 132, 142, 152, 162 supporting the tandem use using the lookup table in the memory 230 of the battery charger 102. Based on the identification of the power tool 132, 142, 152, 162 using the shared memory of the access point 122, the charger electronic controller 210 may determine that the power tool 132, 142, 152, 162 within a communication range is configured to use battery packs 112, 114 in tandem. In other examples, the shared memory space may be in the server 126 rather than the access point 122. Based on this condition with or without other conditions, the charger electronic controller 210 may determine the tandem use information for the two or more battery packs 112, 114, indicating that the two or more battery packs are intended for use on a power tool in tandem.

### 2) Battery Information Determination Based on Tandem Use History

In other examples, the charger electronic controller 210 may determine that the two or more battery packs 112, 114 have been used on a power tool in tandem. For example, a battery pack 112, 114 may include an indication that the battery pack 112, 114 has been used on a power tool in tandem. The indication may be a Boolean value, a number, a symbol, or any other suitable indication. In some examples, the indication may indicate whether the battery pack 112, 114 has been used on a power tool in tandem or not. The indication may be stored in the memory 330 (e.g., a shared memory space) of the battery pack 112, 114. Thus, the charger electronic controller 210 of the battery charger 102 may obtain the indication of the battery pack 112, 114 by accessing the memory 330 (e.g., a shared memory space) of the battery pack 112, 114 received in a charging dock 104 via connected interfaces 242, 342 of the battery pack 112, 114 and the battery charger 102, respectively. In some examples, the charger electronic controller 210 may determine that the two or more battery packs 112, 114 have been used on a power tool in tandem when each of the two or more battery packs 112, 114 provides an indication that the battery pack 112, 114 has been used on a power tool in tandem. For example, when the power tool uses the two or more battery packs 112, 114 in tandem, the power tool may log an indication on the memory in each of the two or more battery packs 112, 114 indicating that each of the two or more battery packs 112, 114 have been used on the same power tool at the same time. The two or more battery packs 112, 114 may then report being used in tandem to the battery charger 102 when the two or more battery packs 112, 114 are received in the battery charger 102.

In some instances, the indication may be a counter indicating the total number of times that the battery pack 112, 114 has been used on a power tool in tandem. That is, when the battery pack 112, 114 is used for the tandem use, the battery pack 112, 114 may add one to the counter. In some scenarios using the counter, the charger electronic controller 210 of the battery charger 102 may determine that the battery pack 112, 114 has been used on a power tool in tandem when the counter is greater than a predetermined value. Thus, when the battery pack 112, 114 has been used on a power tool in tandem more than a predetermined number of times, the battery charger 102 may determine that the battery pack 112, 114 has been used on a power tool in tandem. In some examples, the charger electronic controller 210 may determine that the two or more battery packs 112, 114 have been used on a power tool in tandem when each of the two or more battery packs 112, 114 has the respective counter greater than a predetermined value. In other examples, the charger electronic controller 210 may determine that the two or more battery packs 112, 114 have been used on a power tool in tandem when at least one of the two or more battery packs 112, 114 has the respective counter greater than a predetermined value. In other instances, the indication may be any other suitable metric. For example, the metric may be a tandem use proportion, a First-In, First-Out (FIFO) average, or any other suitable symbol or calculation to indicate that the battery pack 112, 114 has been used in tandem. The metric could be based on individual uses, duration, total energy during use, etc.

In further examples, the charger electronic controller 210 may generate and manage the indication for each battery pack 112, 114 to determine that the two or more battery packs 112, 114 have been used on a power tool in tandem. For example, when the charger electronic controller 210 determines that the two or more battery packs are intended for use on a power tool in tandem based on the conditions explained above, the charger electronic controller 210 may generate a list of the battery packs. Each of the battery packs in the list may indicate that the respective battery pack 112, 114 has been used on a power tool in tandem. The charger electronic controller 210 may similarly use the counter for the indication as explained above. In further examples, the battery charger 102 may identify the presence of one or more battery packs 112, 114 being used in tandem. That suggests the battery packs 112, 114 and/or other battery packs 112, 114 are likely to be in tandem use in future. For example, the battery charger 102 may identify a nearby tool that can use two or more battery packs 112, 114 in tandem or other battery packs 112, 114 that are nearby or recently coupled to the charger 102 that have been employed for tandem use. In some examples, the battery charger 102 may identify the nearby tool or other battery packs 112, 114 via a wireless access point wirelessly using one or more of the Bluetooth® protocol, Wi-Fi protocol, cellular protocol, or the like. In other examples, the battery charger 102 may identify the nearby tool or other battery packs 112, 114 via a global navigation satellite system (GNSS) modules of the nearby tool). In further examples, the battery packs 112, 114 may report their tandem use to the server 126 connected to the network 126 when the battery packs 112, 114 are connected to the network 124 via the access point. In even further examples, the charger electronic controller 210 may determine that unused or relatively new battery packs may be used in tandem as a default setting (or determine that unused or relatively new battery packs may be used for non-tandem use as a default setting).

### 3) Battery Pack Charging Based on Determined Tandem Use Information

In block 430, the charger electronic controller 210 may charge the one or more battery packs 112, 114 based on the battery information determined in block 420. That is, the charger electronic controller 210 may adaptively charge the two or more battery packs 112, 114 based on the battery information indicating the tandem use information. In some instances, the charger electronic controller 210 may charge the two more battery packs 112, 114 for the tandem use with a higher priority than other battery packs received in the battery charger 102. As described above, charging a battery pack with a higher priority may, for example, include the charger electronic controller 210 charging the battery packs having the higher priority and not charging other battery packs connected to the battery charger 102 (and having a lower priority). In other examples, charging a battery pack with a higher priority may, for example, include the charger electronic controller 210 charging the battery packs having the higher priority with a higher charger current than other battery packs connected to the battery charger 102 (and having a lower priority). In other instances, the charger electronic controller 210 may charge the two more battery packs 112, 114 for the tandem use with the fast charge mode. As described above, the fast charge mode is configured to charge the battery pack 112, 114 faster than the normal charge mode by increasing the charging power, charging current, or charging voltage. On the other hand, the charger electronic controller 210 may charge the two more battery packs 112, 114 for the tandem use with a slow charge mode. The slow charge mode is configured to charge the battery pack 112, 114 slower than the normal charge mode by decreasing the charging power, charging current, or charging voltage relative to the normal charge mode. The slow charge mode might preserve battery life. In further instances, the battery charger 102 may have separate charging docks 104 for battery packs for the tandem use together to have similar battery degradation or capacity loss rates or to recognize that the battery packs 112, 114 are received together in the charging docks 104.

In some examples, the charger electronic controller 210 may adaptively charge battery packs 112, 114 for the tandem use based on battery levels of the battery packs 112, 114. The battery level of a battery pack may include, for example, one or more of: a voltage level, an energy level, or a battery resistance level of the battery pack. The voltage level may indicate, in some examples, the terminal voltage or an open-circuit voltage of the battery pack 112, 114. The energy level may indicate, for example, a state of charge, or the level of charge of the battery pack 112, 114 relative to its capacity. In some examples, the energy level may be estimated (e.g., using the current integration in time). The battery resistance level may indicate, in some scenarios, the internal resistance of the battery pack 112, 114. In some examples, the charger electronic controller 210 may obtain the internal resistance of the battery pack 112, 114 based on its terminal voltage with a load.

In some examples, to adaptively charge battery packs 112, 114 for tandem use based on battery levels of the packs, the charger electronic controller 210 is configured to charge a first pack of two battery packs (e.g., battery packs 112, 114) connected to the battery charger 102 until the first pack has the same or similar battery level (e.g., within a threshold tolerance) as a second pack of the two battery packs. Then, the charger electronic controller 210 proceeds to charge the first and second packs in parallel such that the first and second battery packs may have a similar battery level during the remainder of the charging process until charging is complete.

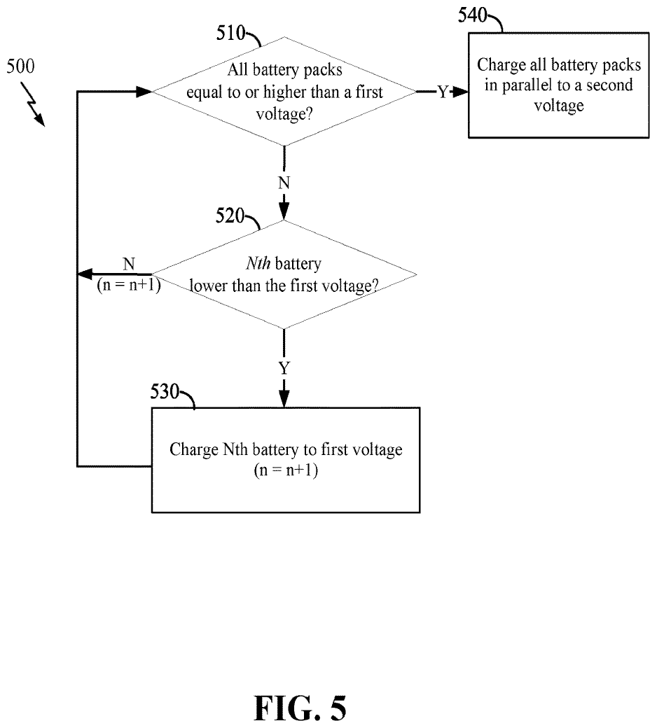

In some examples, to adaptively charge battery packs 112, 114 for tandem use based on battery levels of the packs, the charger electronic controller 210 is configured to execute the process 500 of FIG. 5. In block 510 of the process 500, the charger electronic controller 210 may measure two or more voltage levels corresponding to the two or more battery packs 112, 114 and determine whether each battery pack has equal to or higher than a first predetermined voltage level. The first predetermined voltage may be a set threshold based on a nominal voltage of the battery packs (e.g., approximately 16 volts for a battery pack having a nominal voltage of 18 volts) or may be determined based on a battery level of the battery packs. For example, the first predetermined voltage level may be a highest voltage level of the battery packs to be charged for tandem use, which the charger electronic controller 210 may determine through a voltage measurement at the start of the process 500. The way to measure the voltage levels is substantially similar as explained above (e.g., measuring the terminal voltages or open-circuit voltages of the battery packs 112, 114).

In block 520, the charger electronic controller 210 may determine whether each battery pack of the two or more battery packs 112, 114 has lower than the first predetermined voltage. When an Nth battery pack does not have lower than the first predetermined voltage, the charger electronic controller 210 may look at an N+1th battery pack (e.g., by incrementing N and looping back through block 510 to block 520).

In block 530, when the Nth battery pack has lower than the first predetermined voltage, the charger electronic controller 210 may charge the Nth battery pack to the first predetermined voltage with a higher priority than other battery packs. In some examples, the charger electronic controller 210 may charge the Nth battery pack first and does not charge other battery packs in the battery charger 102. In other examples, the charger electronic controller 210 may provide more charging current to the Nth battery pack that other battery packs and reduce time for the Nth battery pack to be charged to the first predetermined voltage. When the Nth battery pack reached the first predetermined voltage, the charger electronic controller 210 may look at an N+1th battery pack. In some examples, when there are multiple battery packs having lower than the first predetermined voltage, the charger electronic controller 210 may sequentially charge the multiple battery packs one at a time to the first predetermined voltage, or charge alternately or in parallel the battery packs to the first predetermined voltage together. After the iteration of blocks 510-530, the charger electronic controller 210 may determine that all battery packs 112, 114 may have equal to or higher than the first predetermined voltage.

In block 540, the charger electronic controller 210 may charge all battery packs of the two or more battery packs in parallel to a second predetermined voltage (e.g., 19 volts or higher volts for the battery pack having a nominal voltage of 18 volts, the charge voltage, or the target voltage corresponding to a given maximum charge target). Parallel charging may include providing charging current simultaneously to each battery pack being charged in parallel. In some embodiments, parallel charging may include switching, or rapidly switching, the battery pack to which the battery charger 102 is supplying charging current, such that the battery packs, in effect, experience a similar increase in their respective states of charge over time. For example, the battery charger 102 may supply charging current to a first battery pack for 1 second, to a second battery pack for 1 second, again to the first battery pack for 1 second, again to the second battery pack for 1 second, and so on, alternating between packs but, effectively, charging the packs in parallel. At least in some examples, since all battery packs of the two or more battery packs already have the first predetermined voltage, the battery packs may provide sufficient time for a power tool to operate, and the two or more battery packs may be removed from the battery charger 102 and used to power a power tool in tandem any time in block 540.

In some examples, the charger electronic controller 210 may select the two or more battery packs for the tandem use among a plurality of battery packs in the battery charger 102 based on the voltage levels. For examples, three battery packs having corresponding voltages (battery pack 1 having 17 volts, battery pack 2 having 16 volts, and battery pack 3 having 13 volts) are received in the battery charger 102. The charger electronic controller 210 may select two out of the three battery packs having the highest voltages (battery pack 1 having 17 volts and battery pack 2 having 16 volts) for the tandem use. The charger electronic controller 210 may then charge battery pack 2 having a lower voltage than battery pack 1 to a first predetermined voltage (e.g., 17 volts) in block 530, and charge in parallel battery pack 1 and 2 to a second predetermined voltage (e.g., 18 volts) in block 540. It should be appreciated that the selection of battery packs having highest voltages is a mere example. Any other suitable rationale to select battery packs for the tandem use is possible.

### 2. End-of-Use Information

Returning to FIG. 4, in block 420, the charger electronic controller 210 may determine the battery information that indicates the end-of-use information for the one or more battery packs 112, 114. In some scenarios, the charger electronic controller 210 may adaptively charge a battery pack 112, 114 and improve effectiveness and efficiency to use the battery pack 112, 114 when the charger electronic controller 210 may know or correctly predict the end-of-use information (e.g., why the battery pack 112, 114 or the power tool 132, 142, 152, 162 ceases operation). For determining the end-of-use information, the charger electronic controller 210 may determine one or more of: 1) that the one or more battery packs reached a low voltage at which a power tool using the one or more battery packs ceases operation, 2) that the one or more battery packs reached a first thermal limit at which the one or more battery packs cease operation, 3) that the power tool that used the one or more battery packs reached a second thermal limit at which the power tool ceases operation, 4) that the one or more battery packs reached a predetermined level of reduced performance (also referred to as reduced battery capability) or 5) that the one or more battery packs reached a predetermined level of capacity loss. In other examples, the charger electronic controller 210 may determine the end-of-use information based on one or more of: an ambient temperature, a time of the one or more battery packs to be placed in the battery charger, or prior end-of-use information of the one or more battery packs. Based on the determination of the end-of-use information, the charger electronic controller 210 may optimally charge, or otherwise adjust charging of, the one or more battery packs 112, 114. Each factor to determine the end-of-use information and charging based on the respective factor is further explained below.

### 1) End-of-Use Information Determination Based on Low Voltage Level

In some aspects, the end-of-use information may be based on the charger electronic controller 210 determining that the one or more battery packs 112, 114 reached a low voltage at which a power tool using the one or more battery packs ceases operation. Here, the low voltage may, for example, indicate a cut-off voltage, a predetermined voltage, or a voltage at a predetermined state of charge. In some scenarios, a battery pack 112, 114 may be received in the battery charger 102 when a power tool 132, 142, 152, 162 consumed all available battery power of the battery pack 112, 114 (e.g., the battery voltage has reached a cut-off voltage or the battery pack has reached a minimum or 0% state of charge). In other scenarios, a battery pack 112, 114 may be received in the battery charger 102 when the battery pack 112, 114 may experience a sudden substantial voltage drop to the low voltage.

In some examples, the charger electronic controller 210 may obtain the end-of-use information by identifying that the one or more battery packs reached a low voltage at which a power tool using the one or more battery packs ceases operation. Here, the end-of-use information may include the low voltage level of the one or more battery packs or an indication that the one or more battery packs reached the low voltage. It should be understood that the end-of-use information may be any other suitable number, symbol, text or any suitable format to indicate that the one or more battery packs 112, 114 reached the low voltage. In some scenarios, the one or more battery packs 112, 114 may record its voltage level in the memory 330 when the one or more battery packs are detached from a power tool 132, 142, 152, 162. Alternatively, the one or more battery packs 112, 114 may record its voltage level when its voltage level is at or less than a predetermined voltage (e.g., 0.1 volt higher than the cut-off voltage) or the state of charge is less than a predetermined level (e.g., 5% state of charge). Then, the charger electronic controller 210 may access the memory 330 of the one or more battery packs 112, 114 to obtain the end-of-use information (e.g., the low voltage of one or more battery packs 112, 114 or the indication that the voltage reached the low voltage) or otherwise receive the end-of-use information from the one or more battery packs 112, 114.

In other scenarios, the charger electronic controller 210 may determine the end-of-use information. For example, when the one or more battery pack 112, 114 are received by the battery charger 102, the charger electronic controller 210 may measure the voltage of the one or more battery packs 112, 114. When the measured voltage level is equal to or below the low voltage (e.g., the cut-off voltage, a predetermined voltage, or a voltage at a predetermined state of charge (0) %)), the charger electronic controller 210 may determine that the one or more battery packs 112, 114 reached the low voltage at which a power tool using the one or more battery packs ceases operation.

### 2) End-of-Use Information Determination Based on Thermal Limit of Battery Pack

In other aspects, the end-of-use information may be based on the charger electronic controller 210 determining that the one or more battery packs reached a thermal limit at which the one or more battery packs cease operation. For example, when a power tool 132, 142, 152, 162 with a battery pack 112, 114 operates constantly for a long period of time or operates at a place with a hot temperature, the battery pack 112, 114 might be overheated and reach a predetermined thermal limit. Then, the battery pack 112, 114 may, for example, cease operation (e.g., cease outputting power to the battery pack 112, 114) for a suitable reason (e.g., for preserving the battery life and/or preventing damage on the battery pack). Since the battery pack 112, 114 ceases operation due to the high temperature of the battery pack, the battery pack 112, 114 may, in some examples, not have reached the cut-off voltage or 0% state of charge.

In some examples, the charger electronic controller 210 may obtain the end-of-use information from the one or more battery packs 112, 114. Here, the end-of-use information may include an indication of the temperature of the one or more battery packs 112, 114 when the battery pack cease operation or a simple indication that the one or more battery packs reached the thermal limit. It should be understood that the end-of-use information may be any other suitable number, symbol, text or any suitable format to indicate that the one or more battery packs 112, 114 reached the thermal limit. In some scenarios, the one or more battery packs 112, 114 may measure its temperature using a temperature-measurement sensor (e.g. of the electronic components 350) in the one or more battery packs 112, 114 when the one or more battery packs 112, 114 cease operation. Then, the one or more battery packs 112, 114 may record the temperature in the memory 330. Alternatively, the one or more battery packs 112, 114 may record its temperature when the temperature is above the predetermined thermal limit. Then, the charger electronic controller 210 may access the memory 330 of the one or more battery packs 112, 114 to obtain the end-of-use information (e.g., the temperature of one or more battery packs 112, 114 or the indication that the temperature is above the thermal limit) or receiving the end-of-use information from the one or more battery packs 112, 114.

In other examples, the charger electronic controller 210 may determine the end-of-use information. For example, when the one or more battery pack 112, 114 are received by the battery charger 102, the charger electronic controller 210 may directly measure the temperature of the one or more battery packs 112, 114 using a temperature sensor (e.g. of the electronic components 250). In other examples, the charger electronic controller 210 may communicate with the battery pack controller 310 to request and receive a temperature measurement from the temperature-measurement sensor equipped in the one or more battery packs 112, 114. When the measured temperature of the one or more battery packs 112, 114 reached the thermal limit (or another thermal limit considering the cooling period from the time to cease operation to the time to be received in the battery charger 102), the charger electronic controller 210 may determine that the one or more battery packs 112, 114 reached the thermal limit at which a power tool using the one or more battery packs ceases operation.

### 3) End-of-Use Information Determination Based on Thermal Limit of Power Tool

In further aspects, the end-of-use information may be based on the charger electronic controller 210 determining that the power tool 132, 142, 152, 162 that used the one or more battery packs reached another thermal limit at which the power tool ceases operation. This is similar to the end-of-use information determination based on the thermal limit of the one or more battery packs 112, 114 except that the power tool 132, 142, 152, 162 measures the temperature of the power tool and provides, to the one or more battery packs 112, 114 or the battery charger 102, the temperature that is higher than the predetermined thermal limit of the power tool 132, 142, 152, 162 (or an indication thereof). Thus, the charger electronic controller 210 may access the memory 330 of the one or more battery packs 112, 114 to obtain the end-of-use information (e.g., the temperature of the power tool 132, 142, 152, 162 or the indication that the temperature of the power tool 132, 142, 152, 162 is above the predetermined thermal limit of the power tool) or otherwise receive the end-of-use information from the one or more battery packs 112, 114.

### 4) End-of-Use Information Determination Based on Reduced Battery Capability

In further aspects, the end-of-use information may be based on the charger electronic controller 210 determining that the one or more battery packs 112, 114 reached a predetermined level of reduced performance (also referred to as reduced battery capability). For example, one of the battery packs 112, 114 may be removed from a power tool early (e.g., with 10%, 15%, 20%, 25%, 30%, 40%, or 50% state of charge) instead of at a point when the battery pack 112, 114 reaches full discharge (e.g., when the cut-off voltage if reached). In some examples, the user may elect to remove the battery pack 112, 114 early because the performance of the tool has decreased with a low state of charge (and especially with a small/non-high-output-chemistry battery). That is, the one or more battery packs 112, 114 may not be able to output power at a satisfactory level (e.g., at a predetermined level for a particular moment or for a particular duration). Accordingly, in some examples, the charger electronic controller 210 may determine that the end-of-use information indicates a reduced battery capability based on determining that the battery pack 112, 114, at the time of removal from the power tool, was not capable of achieving a particular minimum output power, of sustaining a minimum output power for a given runtime, or of meeting some other metric (e.g., a subjective metric of a user).

In some examples, the charger electronic controller 210 may obtain or measure the end-of-use information from the one or more battery packs 112, 114. Here, the end-of-use information may include the level of battery performance (or battery capability), which may include a state-of-charge of the one or more battery packs 112, 114 or a recent (or most recent) output power level (e.g., instantaneous, average, or maximum sustained level for a particular duration) at the time of removal from the power tool. The charger electronic controller 210 may compare that obtained level of battery performance to a minimum performance threshold. In some examples, when the charger electronic controller 210 determines that the obtained level of battery performance is below the minimum performance threshold, the charger electronic controller 210 may determine that the end-of-use information indicates that the end-of-use was due to reduced battery capability. Accordingly, the charger electronic controller 210 may determine that the battery pack 112, 114 has a reduced capability when the battery pack 112, 114 is not capable of achieving a particular minimum output power or achieving a particular runtime at a minimum output power. In some examples where the state-of-charge of the battery pack 112, 114 is used as the level of battery performance, the charger electronic controller 210 may determine that the end-of-use information indicates that the end-of-use was due to reduced battery capability when the charger electronic controller 210 determines that the obtained level of battery performance is both below the minimum performance threshold and also above the cut-off threshold of the pack.

### 5) End-of-Use Information Determination Based on Battery Capacity Loss

In further aspects, the end-of-use information may be based on the charger electronic controller 210 determining that the one or more battery packs reached a predetermined level of capacity loss. For example, the one or more battery packs 112, 114 may experience degradation over time, and the amount of the capacity loss of the one or more battery packs 112, 114 may reach a predetermined level or more at which a user may find less acceptable. In some examples, the predetermined level of capacity loss indicates that the one or more battery packs 112, 114 reached a depleted energy level.

In some examples, the charger electronic controller 210 may obtain the end-of-use information from the one or more battery packs 112, 114. Here, the end-of-use information may include the level of capacity loss of the one or more battery packs 112, 114 or a simple indication that the one or more battery packs reached the predetermined level of capacity loss. It should be understood that the end-of-use information may be any other suitable number, symbol, text or any suitable format to indicate that the one or more battery packs 112, 114 reached the predetermined level of capacity loss. In some scenarios, the one or more battery packs 112, 114 may measure the peak voltage or the state of charge when the constant charging current decreases or the charge level is saturated. When the peak voltage is less than a predetermined threshold voltage that is less acceptable or the state of charge is less than a predetermined state of charge that is less acceptable, the one or more battery packs 112, 114 may determine that the level of capacity loss reaches the predetermined level of capacity loss. For instance, if the impedance of a battery has considerably risen (e.g., in the case of an old and/or worn battery) the battery may have a high level of capacity loss. In such cases, the battery may be more suitable for lower power demand devices, such as lights or fans, rather than higher power demand devices. In some examples, the one or more battery packs 112 measure the capacity loss based on an amount of time when the one or more battery packs 112, 114 are discharged at a given discharge current (e.g., a C-rate) from 100% state of charge to the cut-off voltage. In addition, in other scenarios, the one or more battery packs 112, 114 may also track the ambient temperature that affects the capacity loss. When the capacity loss of the one or more battery packs 112, 114 reached the predetermined level of capacity loss, the one or more battery packs 112, 114 may record the predetermined level of capacity loss in the memory 330. Alternatively, the one or more battery packs 112, 114 may record an indication that the one or more battery packs 112, 114 reached the predetermined level of capacity loss. Then, the charger electronic controller 210 may access the memory 330 of the one or more battery packs 112, 114 to obtain the end-of-use information (e.g., the level of capacity loss or the indication that the one or more battery packs 112, 114 reached the predetermined level of capacity loss) or receiving the end-of-use information from the one or more battery packs 112, 114.

In other examples, the charger electronic controller 210 may determine the end-of-use information. For example, when the one or more battery packs 112, 114 are received by the battery charger 102, the charger electronic controller 210 may have charged the one or more battery packs 112, 114 and have recorded the peak voltages of the one or more battery packs 112, 114 when its current decreased. Over time, the peak voltage may decrease, and the charger electronic controller 210 may measure the capacity loss (e.g., based on a coulomb counting by integrating the flowing current while charging or discharging to derive the total sum of energy into or out of the battery pack). In other examples, the capacity loss may be measured by accessing the battery state-of-charge and state-of-health information. It should be appreciated that the charger electronic controller 210 may use any other suitable measurement of the capacity loss. When the measured capacity loss of the one or more battery packs 112, 114 reached the predetermined level, the charger electronic controller 210 may determine that the one or more battery packs 112, 114 reached the predetermined level of capacity loss. It should be appreciated that the end-of-use information is not limited to the listed examples.

### 6) Battery Pack Charging Based on Determined End-of-Use Information

Returning to FIG. 4, in block 430, the charger electronic controller 210 may adaptively charge the one or more battery packs 112, 114 based on the battery information determined in block 420. For example, the charger electronic controller 210 may charge the one or more battery packs 112, 114 differently based on a different factor in the battery information determined in block 420.

In some examples, the battery information is based on the electronic controller determining that the one or more battery packs 112, 114 reached a low voltage at which a power tool using the one or more battery packs ceases operation as explained in 1) End-of-use Information Determination Based on Low Voltage Level above. The charger electronic controller 210 may charge the one or more battery packs 112, 114 with the normal charge mode or the fast charge mode. In some examples, the charger electronic controller 210 may charge the one or more battery packs 112, 114 to a full charge capacity of the one or more battery packs 112, 114 or less than the full charge capacity (e.g., 80%) for preserving the battery life. In further examples, the charger electronic controller 210 may consider the time to charge the one or more battery packs 112, 114. For example, when the time that the one or more battery packs 112, 114 reached the low voltage is within normal business hours (e.g., 9 am to 5 pm, or 6 am to 3 pm), the charger electronic controller 210 may charge the one or more battery packs 112, 114 with a fast charge mode and/or to a reduced maximum charge level (e.g., 80%). This fast charging and/or reduced maximum charge may be used because the one or more battery packs 112, 114 may be used again before the end of the business day, may not need to be fully-charged to power a power tool through the end-of the day, and/or may be desired by an operator for use sooner even if the power tool battery pack may not be fully charged (e.g., to 100%). In some examples, the charger electronic controller 210 may track when the one or more battery packs are used (e.g., may determine prior usage history) to define normal business hours for the one or more battery packs. For example, the charger electronic controller 210 may identify that the one or more battery packs were used generally between 6 am and 2 pm, and set normal business hours to be between 6 am and 2 pm by storing this time range in a memory of the pack (e.g., memory 230)) or charger (e.g., memory 330). Thus, the charger electronic controller 210) may determine to use the fast charge mode or the normal charge mode based on the prior usage history of the one or more battery packs 112, 114. The charger electronic controller 210 may be further configured to use a normal charge mode (e.g., with a charging rate that is less than the charging rate of a fast charge mode) and/or a normal maximum charge threshold (e.g., 100%) when the charger electronic controller 210 detects that the time that the one or more battery packs 112, 114 reached the low voltage was outside of normal business hours.

In other examples, the battery information is based on the electronic controller determining that the one or more battery packs reached the first thermal limit or the power tool using the one or more battery packs reached the second thermal limit as explained in 2) End-of-use Information Determination Based on Thermal Limit of Battery Pack and 3) End-of-use Information Determination Based on Thermal Limit of Power Tool above). That is, the one or more battery packs 112, 114 may be received by the battery charger 102 not due to a low battery energy but due to overheating on the battery pack-side or the power tool-side. Based on the prior end-of-use being related to over-heating, the charger electronic controller 210 may predict or presume that the battery packs 112, 114 may again be used in a similar scenario in which an end-of-use may be due to overheating. Accordingly, based on this determined overheating, the charger electronic controller 210 may, for example, charge the one or more battery packs 112, 114 less than a full charge capacity of the one or more battery packs because the full capacity may not be necessary (if the battery packs 112, 114 will overheat before complete discharge anyway) and because not charging to the full charge capacity may preserve battery life of the battery packs 112, 114. Additionally or alternatively, in some examples, based on this determined overheating, the charger electronic controller 210 may charge the one or more battery packs 112, 114 slower than the normal charge mode (i.e., with a lower charge rate). By slowing the charging rate, the charger electronic controller 210 may avoid adding as much heat to the one or more battery packs 112, 114. Accordingly, at the completion of charging, the one or more battery packs 112, 114 may have a lower internal temperature and, thus, may be able to be used for a longer period of time in the high-demand scenario that previously caused over-heating. Additionally or alternatively, in some examples, based on this determined overheating, the charger electronic controller 210 may charge the one or more battery packs 112, 114 in parallel with other battery packs in the battery charger. Such parallel charging may correspond to lower charge rate per pack (as available charging power is shared among the multiple packs).

In further examples, the battery information is based on the electronic controller determining that the one or more battery packs 112, 114 reached a predetermined level of performance as explained in 4) End-of-use Information Determination Based on Reduced Battery Capability above. In some examples, the charger electronic controller 210 may charge the one or more battery packs 112, 114 with a fast charge mode and/or to a reduced maximum charge level (e.g., 80%) to preserve battery life. In other examples, the charger electronic controller 210 may charge the one or more battery packs 112, 114 with a fast charge mode and/or to a maximum charge level (e.g., 100%) because the one or more battery packs 112, 114 are being used for a power tool requiring a high-power level for operation.

In further examples, the battery information is based on the electronic controller determining that the one or more battery packs 112, 114 reached a predetermined level of capacity loss as explained in 5) End-of-use Information Determination Based on Battery Capacity Loss above. In some examples, the charger electronic controller 210 may charge the one or more battery packs 112, 114 based on the end-of-use information indicating that the one or more battery packs 112, 114 has reached the predetermined level of capacity loss. For example, when the capacity loss is severe enough to reach the predetermined level, the charger electronic controller 210 may charge the one or more battery packs 112, 114 to a higher minimum level of charge (e.g., the controller 210 may increase a minimum level of charge, from a first level to a higher level, that is to be achieved before charging is ceased) to provide a runtime that is satisfactory to a user. Additionally or alternatively, the charger electronic controller 210 may, for example, indicate to the user, that the one or more battery packs should be replaced or used to power devices having lower power demand (e.g., fans or lights). For example, the charger electronic controller 210 may transmit the indication to a software application in a mobile device that is connected to the same network 124 as the battery charger 102. In other examples, the charger electronic controller 210 may transmit the indication to the server 126 that will transmit to the user with a suitable message. In some instances, the charger electronic controller 210 may find another battery pack 112, 114 received by the battery charger 102 and indicate another battery pack 112, 114 to the operator. The other battery pack 112, 114 may have more than a predetermined voltage or a predetermined state of charge (e.g., 70%) that is sufficient for a power tool to operate for a predetermined period of time.

In further examples, the charger electronic controller 210 may adaptively charge the one or more battery packs 112, 114 based on the ambient temperature of the one or more battery packs 112, 114. For example, the charger electronic controller 210 may detect that the ambient temperature is higher than a predetermined temperature (e.g., 90°) F.). Then, the charger electronic controller 210 may disable or bypass the fast charge mode to avoid additional heat in the one or more battery packs 112, 114 and charge the one or more battery packs 112, 114 with the normal charge mode (or with a slower than normal charge mode).

### 3. User Preference Information

Returning to FIG. 4, in block 420, the charger electronic controller 210 may determine the battery information that indicates the user preference information for the one or more battery packs 112, 114. In some examples, the user preference information may be derived from one or more of: 1) past charging. 2) manner-of-insertion, or 3) a wireless interface. In some examples, a user of the one or more battery packs may have (knowingly or unknowingly) a preference (e.g., past charging, manner-of-insertion, or a wireless interface, etc.) of the way of charging the one or more battery packs. The charger electronic controller 210 may identify the user preference and adaptively charge the one or more battery packs based on the user preference.

### 1) User Preference Information Determination Based on Past Charging

In some examples, the charger electronic controller 210 may determine the user preference information based on past charging of the one or more battery packs 112, 114. For example, the past charging is based on the charger electronic controller 210 determining that one or more of: the one or more battery packs had a higher priority than another battery pack in the battery charger, the one or more battery packs were charged with a fast charging rate faster than a normal charging rate, the one or more battery packs were removed from the battery charger before being fully charged, or the one or more battery packs were received by the battery charger with a high speed or a high force on the battery charger.

In some examples, the user preference information indicating past charging is based on the charger electronic controller 210 determining that the one or more battery packs 112, 114 had a higher priority than another battery pack connected to the battery charger 102. The user preference information may include, for example, the number of past chargings with the higher priority or an indication that the one or more battery packs 112, 114 had a higher priority. For example, the one or more battery packs 112, 114 may have been previously charged with the higher priority in response to detecting user-actuation of a high priority button of the battery charger 102, a request through the user's mobile device, or any other suitable means to set the higher priority for the one or more battery packs 112, 114. Then, the charger electronic controller 210 may have recorded the user preference information in the memory 330 (e.g., a shared memory space) of the one or more battery packs 112, 114 or in the memory 230 of the battery charger with the battery identification number. When the one or more battery packs 112, 114 are received by the battery charger 102, the charger electronic controller 210 may identify the user preference information in the memory 330 of the one or more battery packs 112, 114 or in the memory 230 of the battery charger 102.

In other examples, the user preference information indicating the past charging is based on the charger electronic controller 210 determining that the one or more battery packs were charged with a fast charging rate faster than a normal charging rate. The user preference information may include, for example, the number, proportion, or recent number of chargings with the fast charging rate or an indication that the one or more battery packs 112, 114 had the fast charging rate. For example, the one or more battery packs 112, 114 may have been previously charged with the fast charging rate (e.g. the fast charge mode) in response to user-actuation of a button of the battery charger 102, a request through the user's mobile device, or any other suitable means to set the fast charging rate for the one or more battery packs 112, 114. The way to store and retrieve the user preference information may be substantially similar to the information related to the past charging with the higher priority described above.

In further examples, the user preference information indicating the past charging is based on the charger electronic controller 210 determining that the one or more battery packs 112, 114 were removed from the battery charger 102 before being fully charged. The user preference information may include, for example, the number of chargings with removals of the one or more battery packs 112, 114 before being fully charged or an indication that the one or more battery packs 112, 114 were removed from the battery charger 102 before being fully charged. For example, when the one or more battery packs 112, 114 were removed from the battery charger 102, the one or more battery packs 112, 114 or the charger electronic controller 210 of the battery charger may record the energy level (e.g., the state of charge, the terminal/open-circuit voltage, or any other suitable means to indicate the battery energy level). In other examples, the one or more battery packs 112, 114 or the charger electronic controller 210 of the battery charger may record how many times or with what frequency the one or more battery packs 112, 114 were removed from the battery charger 102 before being fully charged. In further examples, the one or more battery packs 112, 114 or the charger electronic controller 210 of the battery charger may record an indication that the one or more battery packs 112, 114 were removed from the battery charger 102 before being fully charged. In some scenarios, the charger electronic controller 210 may further indicate, in the user preference information, frequent removal of the one or more batteries from the one or more charging docks 104. For example, the user may frequently charge and remove the one or more battery packs 112, 114 before being fully charged (e.g., once per day or more frequently) to have more power and potentially more runtime per day. The charger electronic controller 210 may reflect the user preference in the user preference information. In some examples, when the one or more battery packs 112, 114 are charged and removed more than once per day, the charger electronic controller 210 of the battery charger 102 or the one or more battery packs 112, 114 may indicate frequent charge and early removal of the one or more battery packs 112, 114. The way to retrieve the user preference information may be substantially similar to the information related to the past charging with the higher priority as described above. The charger electronic controller 210 may adaptively charge the one or more battery packs 112, 114 based on the user preference information.

In further examples, the user preference information indicating the past charging is based on the charger electronic controller 210 determining that the one or more battery packs 112, 114 were received by the battery charger 102 with a high speed or a high force on the battery charger 102. In some examples, the high speed may be faster than a threshold speed, and the high force may be more forceful than a threshold force. The user preference information may include, for example, the number of chargings with the high speed or the high force on the battery charger 102 or an indication that the one or more battery packs 112, 114 were charged with the high speed or the high force. For example, the battery charger 102 may include a force sensor (e.g., as part of the electronic components 250) to measure a force to the charging dock 104 when the one or more battery packs 112, 114 are received by the charging dock 104. The force sensor may output a signal (e.g., a voltage or millivolts per volt, any other suitable output signal measurement) indicating the force to the charging dock 104 by the one or more battery packs 112, 114. When the output signal is more than a predetermined threshold indicating a pack was received with at least a threshold force, or when the output signal changes at least a predetermined amount over a certain period of time indicating the pack was received with at least a threshold speed, the charger electronic controller 210 may record how many times the one or more battery packs 112, 114 were received to the battery charger 102 with the high force or the high speed. In further examples, the charger electronic controller 210 of the battery charger may record an indication that the one or more battery packs 112, 114 were received to the battery charger 102 with the high force or the high speed. The way to retrieve the user preference information may be substantially similar to the information related to the past charging with the higher priority as described above. The charger electronic controller 210 may adaptively charge the one or more battery packs 112, 114 based on the user preference information.

### 2) User Preference Information Determination Based on Manner-of-Insertion

In some examples, the charger electronic controller 210 may determine the user preference information based on the manner-of-insertion of the one or more battery packs 112, 114. The user preference information may be determined based not just on past charging determining the manner-of-insertion as explained above, but on the current manner-of-insertion. The way to measure the insertion force and speed on the battery charger 102 may be substantially similar as explained above. Here, the user preference information may include an indication that the one or more battery packs 112, 114 are received to the battery charger 102 with the high force or the high speed. In further examples, the user preference information may include a bounce pattern. For example, a high rate of insertion/removal speed or a low rate of insertion/removal speed for connecting or disconnecting a battery pack 112, 114 to the battery charger 102 or the power tool can cause a different bounce pattern. The different bounce pattern may be detected and used to gather information on the speed and/or force of insertion. The charger electronic controller 210 may adaptively charge the one or more battery packs 112, 114 based on the user preference information.

### 3) User Preference Information Determination Based on Wireless Interface

In some examples, the charger electronic controller 210 may determine the user preference information based on a wireless interface (e.g., the transceiver 240 and/or a wireless interface of the battery pack interface 242). The wireless interface may, for example, indicate wireless connection (e.g., via the Bluetooth protocol, the Wi-Fi protocol, or the cellular protocol). For example, the charger electronic controller 210 may obtain or update the battery information indicating the user preference information via the wireless interface. In some examples, another device (e.g., the server 126, the power tool 132, 142, 152, 162, user's mobile device, or any other suitable device to transmit data) may create and/or update/customize the user preference information as described above. For example, the device may update, modify, or customize the user preference information that was generated based on the past charging or manner-of-insertion, where the updates, modifications, and/or customizations are based on user input at the device. Then, the device may transmit the updated user preference information to the battery charger 102 via the wireless interface. The charger electronic controller 210 may receive the user preference information via the transceiver 240 and may update the user preference information stored in the memory 230. In further examples, when the one or more battery packs 112, 114 have the user preference information in the memory 330 of the battery packs, the charger electronic controller 210 may update the user preference information stored in the memory 330 via the interfaces 242 and 342.

### 4) Battery Pack Charging Based on Determined User Preference Information

In block 430, the charger electronic controller 210 may charge the one or more battery packs 112, 114 based on the battery information determined in block 420. That is, the charger electronic controller 210 may adaptively charge the two or more battery packs 112, 114 based on the battery information indicating the user preference information. In some instances, the charger electronic controller 210 may adaptively charge the one or more battery packs 112, 114 based on the user preference information.

In some aspects of this disclosure, the user preference information may be derived from the past charging indicating that the one or more battery packs 112, 114 had a higher priority than another battery pack connected to the battery charger 102 as explained above. In some examples, the higher priority may, for example, indicate that the charger electronic controller 210 may charge the respective battery pack with the higher priority first and does not charge other battery packs in the charger 102 until the respective battery pack reached a predetermined state of charge. In other examples, the higher priority may, for example, indicate that the charger electronic controller 210 may charge some or all battery packs in parallel in the battery charger 102 but convey more charging current to the respective battery pack with the higher priority than other battery packs. In further examples, the higher priority may, for example, indicate that the charger electronic controller 210 may alternately charge each battery pack for a predetermined time but charge the respective battery pack with the higher priority for a longer period of time than other battery packs. For example, four battery packs (battery packs 1-4) may be received in the battery charger 102 and the user preference information may indicate that battery pack 2 had a higher priority in one or more previous chargings. In some examples, the charger electronic controller 210 may charge battery pack 2 first and charge battery packs 1, 3, and 4 after battery pack 2 reaches a predetermined state of charge. In other examples, the charger electronic controller 210 may charge battery packs 1-4 in parallel but convey more charging current to battery pack 2 than battery packs 1, 3, and 4. The charger electronic controller 210 may employ any other suitable technique to charge battery pack 2 with a higher priority.

Based on the user preference information, the charger electronic controller 210 may charge the one or more battery packs 112, 114 with the higher priority than a different battery pack in the battery charger 102. In some examples, the electronic controller may determine whether to charge the one or more battery packs 112, 114 with the higher priority based on how many times the one or more battery packs had been charged with the higher priority. For example, the electronic controller may charge the one or more battery packs with the higher priority when the one or more battery packs had been charged with the higher priority more than predetermined times (e.g., 2 times). In other examples, the electronic controller may consider the denominator (e.g., the total number of battery charging). Thus, the electronic controller may charge the one or more battery packs with the higher priority when more than a predetermined percentage (e.g., 50%) of the total number of chargings was with the higher priority.

In other aspects of this disclosure, the user preference information may be derived from the past charging indicating that the one or more battery packs were charged with a fast charging rate faster than a normal charging rate as explained above. Here, the fast charging rate may indicate that the charger electronic controller 210 may convey more charging current than the normal charging rate. In response to the user preference information, the electronic controller may charge the one or more battery packs with the fast charging rate. For example, four battery packs (battery pack 1-4) may be received in the battery charger 102 and the user preference information may indicate that battery pack 2 was previously charged with the fast charging rate. Then, the charger electronic controller 210 may charge battery pack 2 with the fast charging rate that is faster than a normal charging rate for battery packs 1, 3, and 4. In other examples, in response to the user preference information, the charger electronic controller 210 may charge the one or more battery packs with the higher priority before other battery packs. For example, when the ambient temperature is higher than a predetermined temperature, the charger electronic controller 210 may charge the one or more battery packs with the higher priority first, while not charging other battery packs connected to the battery charger 102. After the one or more battery packs 112, 114 reach a predetermined state of charge, the charger electronic controller 210 may charge other battery packs in the battery charger 102.

In further aspects of this disclosure, the user preference information may be derived from the past charging indicating that the one or more battery packs were removed from the battery charger 102 before being fully charged as explained above. In response to the user preference information, the electronic controller may, for example, charge the one or more battery packs with the higher priority (e.g., charging the higher priority packs before other packs or with the fast charging rate that is faster than the charge rate used for other packs).

In further aspects of this disclosure, the user preference information may be derived from the past charging indicating that the one or more battery packs 112, 114 were received by the battery charger 102 with the high speed or the high force on the battery charger 102 as explained above. In response to the user preference information, the electronic controller may, for example, charge the one or more battery packs with the higher priority (e.g., charging the higher priority packs before other packs or with the fast charging rate that is faster than the charge rate used for other packs).

In further aspects of this disclosure, the user preference information may be derived from the manner-of-insertion as explained above. In response to the user preference information, the electronic controller may, for example, charge the one or more battery packs with the higher priority (e.g., charging the higher priority packs before other packs or with the fast charging rate that is faster than the charge rate used for other packs).

In further aspects of this disclosure, the user preference information may be derived from the wireless interface. For example, the battery information may be updated via the wireless interface (e.g., a Bluetooth protocol, a Wi-Fi protocol, or a cellular protocol). Thus, the electronic controller may adaptively charge the one or more battery packs 112, 114 based on the updated battery information as explained and exemplified above.

### 4. Other Battery Information

Returning to FIG. 4, in block 420, the charger electronic controller 210 may determine the battery information that indicates the other battery information for the one or more battery packs 112, 114, such as battery capability information and/or battery authenticity information. The charger electronic controller 210 may identify other battery information in block 420 and adaptively charge the one or more battery packs in block 430 based on the user preference.

For example, the charger electronic controller 210 may determine one or more battery characteristics (as battery capability information) of a coupled battery pack, such as oil resistance, water resistance, performance at different temperatures, thermal runaway limits, and/or different form factors or weight. The charger electronic controller 210 may compares such characteristics to thresholds to identify appropriate or desired charging strategies (e.g., stored in a memory of the controller), and then proceed with such charging strategies in block 430. In some examples, these characteristics are sensed by sensors of the charger electronic controller 210 and/or the battery pack communicates these characteristics to the charger electronic controller 210.

As another example for battery capability information, the charger electronic controller 210 may determine characteristics of a battery packs that make them more suitable in certain conditions. For instance, the charger electronic controller 210 may determine, based on identifying a type of battery pack, that the pack has a particular type of circuitry. This circuitry may include buck or boost converters, overload circuitry, overall parameters such as total impedance, fuse properties, or the like. A charger may determine that a battery pack has low impedance properties (e.g., below a threshold) and may determine to increase their effective impedance or decrease their ability to deliver current based on this condition alone or in combination with a determination that a nearby tool (e.g., within communication range of the charger 102) that is less compatible with higher currents or voltages. To increase the effective impedance, the charger electronic controller 210 may, at the start, end, or during charging in block 430, adjust a battery pack impedance setting or minimize the output available from the battery pack (e.g., by adjusting a maximum current or voltage setting of the pack) for compatibility. Similarly, some battery packs may allow voltage above a nominal range (e.g., 12 volts or 18 volts), which may be supported by certain tools configured to receive the higher voltage. The charger electronic controller 210, by setting a voltage output level parameter of the battery pack in block 830, may enable the increased voltage (e.g., in response to detecting nearby tools compatible with the higher voltage) or disable the increased voltage (e.g., in response to not detecting nearby tools compatible with the higher voltage).

In some examples, the charger electronic controller 210 may determine battery authenticity information for a coupled battery pack. For instance, some battery packs may have an internal key, register, electrical properties, ability to provide a handshake, a serial number or other identifier that allows a charger to determine that the battery pack is authentic (as opposed to inauthentic, such as a pack manufacturing by an unauthorized third party). Some inauthentic battery packs may try to emulate the authentication methods, such as by providing a false identification number. In some examples, the charger electronic controller 210 may compare determined identification numbers from a battery pack to a database of known illegitimate packs to determine whether the pack is inauthentic. In some examples, the charger electronic controller 210 may determine that a battery pack deviates slightly from an authentication protocol (e.g., because an authentic battery pack has a degraded or malfunctioning clock that alters a handshake timing) or may determine that a pack is older than certain authentication techniques (e.g., an older pack that was manufactured before certain authentication protocols were implemented). In some examples, the charger electronic controller 210 may use these various sources of information to determine information on the authenticity of a pack, which may include classifying whether a pack is authentic, is likely authentic, is likely inauthentic, and is inauthentic using machine learning algorithms, decision trees, predetermined logic, etc.). The charger electronic controller 210 may then use this classification to select a charging strategy (e.g., each classification may be associated with a charging strategy). The selectively charging strategies may include “bricking” a pack (e.g., permanently disabling the pack), discharging a pack, prioritize charging known authentic packs over packs not known to be authentic, charging known authentic packs faster than other packs not known to be authentic, and the like.

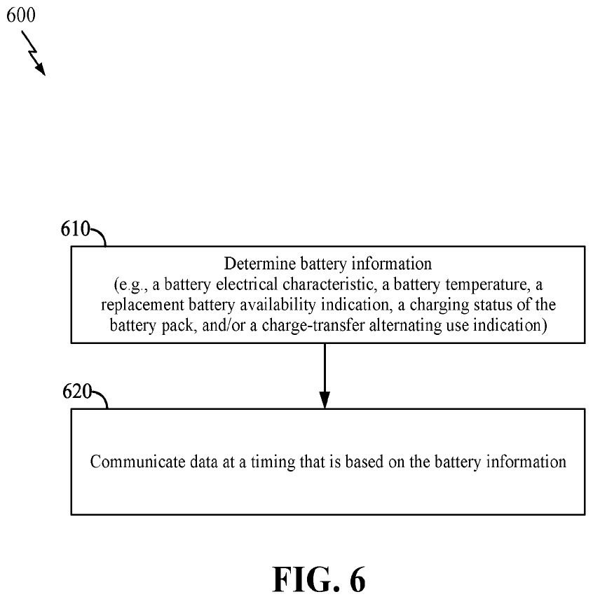

FIG. 6 illustrates a process 600 for adaptive data communication between a power tool battery pack 112, 114 and a power tool battery charger 102. The process 600 is described below as being carried out by the battery charger 102 or the battery pack 112, 114 of the system 100 as illustrated in FIGS. 1-3. For example, the blocks of the process 600 below are described as being executed by the charger electronic controller 210 of the battery charger 102 or the battery electronic controller 310 of the battery pack 112, 114. However, in some embodiments, the process 600 is implemented by another device and/or in another system having additional, fewer, and/or alternative components. For example, the electronic controller 210 as part of one of the chargers illustrated in FIGS. 9A-C, or the electronic controller 310 as part of one of the battery packs illustrated FIGS. 10A-10D may implement the process 600. Additionally, although the blocks of the process 600 are illustrated in a particular order, in some embodiments, one or more of the blocks may be executed partially or entirely in parallel, may be executed in a different order than illustrated in FIG. 6, or may be bypassed.

In some scenarios, a battery pack 112, 114 may have a finite set of pins available when the battery packs communicate with a battery charger 102 via interfaces 242, 342 of the battery pack and the battery charger. This may limit the rate of data communication and the ability to charge while communicating data between the battery pack 112, 114 and the battery charger 102. Thus, determining a timing to communicate data between the battery pack 112, 114 and the battery charger 102 is in need. The exemplified process 600 elaborated below provides solutions to these (and other) problems.

In block 610, an electronic controller (e.g., the charger electronic controller 210 of the battery charger 102 or the battery electronic controller 310 of the battery pack 112, 114) may determine battery information including one or more of: a battery electrical characteristic, a battery temperature, a replacement battery availability indication, a charging status of the battery pack, or a charge-transfer alternating use indication. The battery information may be stored in the memory 230 as battery information 422 (e.g., after being determined by the charger electronic controller 210) and/or may be stored in the memory 330 (e.g., after being determined by the battery electronic controller 310).

In some aspects of this disclosure, the battery information may include the battery electrical characteristic. The battery electrical characteristic of a battery pack may indicate the state of charge of the battery pack, the terminal voltage of the battery pack, the open-circuit voltage of the battery pack, or any other suitable measurement to indicate the available battery energy of the battery pack 112, 114. In some examples, the battery pack 112, 114 (e.g., the battery electronic controller 310 of the battery pack 112 or 114) may measure the battery electrical characteristic (e.g., by measuring the voltage, the specific gravity of the battery electrolyte, or the in-and-out-flowing current of the battery pack 112, 114). In other examples, the battery charger 102 (e.g., the charger electronic controller 210) may receive the measured battery electrical characteristic from the battery pack 112, 114. In further examples, when the battery pack 112, 114 is received by the battery charger 102, the battery charger 102 (e.g., the charger electronic controller 210) may measure the battery electrical characteristic of the battery pack 112, 114 using the similar technique as the battery pack 112, 114.

In other aspects of this disclosure, the battery information may include a battery temperature 615. In some examples, the battery pack 112, 114 (e.g., the battery electronic controller 310 of the battery pack 112 or 114) may measure the temperature of the battery pack 112, 114 using a temperature-measurement sensor (e.g., a thermocouple, a resistance temperature detector, a thermistor, or any other suitable sensor to measure the temperature of the battery pack) in the battery pack 112, 114. In other examples, the battery charger 102 (e.g., the charger electronic controller 210) may receive the temperature measured by the battery pack 112, 114. In further examples, when the battery pack 112, 114 is received by the battery charger 102, the battery charger 102 (e.g., the charger electronic controller 210) may measure the battery temperature 615 of the battery pack 112, 114 received by the battery charger 102. For example, the battery charger 102 may enable the temperature-measurement sensor in the battery pack 112, 114 and obtain the temperature of the battery pack 112, 114. In other examples, the battery charger 102 may have a different temperature-measurement sensor and independently measure the temperature of the battery pack 112, 114 using the similar technique as the battery pack 112, 114.

In further aspects of this disclosure, the battery information may include a replacement battery availability indication. The replacement battery availability indication may, for example, indicate that the replacement battery is available within a predetermined distance from the battery pack 112, 114. In some examples, the predetermined distance may be a particular length (e.g., 5 meters) from the battery pack 112, 114. For example, the charger electronic controller 210 of the battery charger 102 may determine that the replacement battery pack has been received by a different battery charger that is within a predetermined length from the battery pack 112, 114 based on location information of two battery chargers (e.g., using a global navigation satellite system (GNSS) modules of the chargers or measurements of communications between the chargers). In other examples, the charger electronic controller 210 may receive the replacement battery availability indication from another device (e.g., the server 126, another battery charger, etc.) indicating that the replacement battery pack is within the predetermined length from the battery pack 112, 114. In other examples, the predetermined distance may be a communication range of the battery pack 112, 114 and/or the charger 102. For example, the charger electronic controller 210 may determine that the replacement battery pack is within the predetermined distance from the battery pack when a different battery charger receiving the replacement battery pack is connected to the network 124 via the same access point 122 (e.g., the same mobile device, the same Wi-Fi router, etc.) as the battery charger 102 receiving the battery pack 112, 114. In some examples, the charger electronic controller 210 of the battery charger 102 may determine the replacement battery based on the same nominal battery and/or more than a predetermined state of charge (e.g., 50%) of the replacement battery. In some instances, the replacement battery may be received by the same battery charger 102 or a different battery charger close to the battery charger 102.

In further aspects of this disclosure, battery information may include a charging status of the battery pack 112, 114. For example, the charging status of the battery pack 112, 114 may indicate whether the battery pack 112, 114 is in a charging status (e.g., receives charging current from the battery charger 102). The charger electronic controller 210 of the battery charger 102 may determine the charging status of the battery pack 112, 114 by identifying whether the battery charger 102 conveys charging current (e.g., constant charging current) to the battery pack 112, 114. In some examples, the charging status of the battery pack 112, 114 may be identified before the voltage of the battery pack 112, 114 reaches the voltage peak (e.g., the topping voltage or the saturation voltage). On the other hand, the battery pack 112, 114 may also determine the charging status of the battery pack 112, 114 in similar as the battery charger 102. In other examples, the battery pack 112, 114 may receive the charging status of the battery pack 112, 114 from the battery charger 102 or vice versa. In further examples, the charger electronic controller 210 of the battery charger 102 may determine charging statuses of other battery packs in the battery charger 102.

In further aspects of this disclosure, battery information may include a charge-transfer alternating use indication. The charge-transfer alternating use indication may enable the charger electronic controller 210 of the battery charger 102 to alternate between communicating data and charging a connected battery pack.

In further aspects of this disclosure, battery information may include more generally any data stored on the battery pack. This may include historical or logged data on usage of the battery pack, historical or logged data on usage of a power tool (or power tools) to which the battery pack was coupled to or with which the battery pack was otherwise in communication, as well as other data that may be stored on the battery pack. The historical or logged data may include sensor data (from sensors on the battery pack and/or power tool) in raw form or processed form, identification data (e.g., identifying each power tool to which the battery pack has been coupled), runtime data, and the like. In some examples, the battery information includes power tool information stored on the battery pack, which may include basic power tool information (e.g., power tool product identification number, etc.), power tool usage statistics (e.g., running time, running hours, temperatures, etc.), raw sensor data, metadata, or any other suitable power tool information that can be gathered from the power tool. In some examples, usage statistics and raw sensor data may be considered part of the aforementioned historical or logged data on usage of a power tool.

In block 620, the charger electronic controller 210 of the battery charger 102 or the battery electronic controller 310 of the battery pack 112, 114 may communicate data at a timing that is based on the battery information. For example, based on the determined battery information in block 610, the battery charger 102 and/or the battery pack 112, 114 may determine a timing to communicate data and may communicate the data. The communication may include the battery charger 102 transmitting the data to the battery pack 112, 114 (which receives the data): the battery pack 112, 114 transmitting the data to the battery charger 102 (which receives the data), or a combination thereof. Here, the data may indicate summarized recordings (e.g., the number of charger cycles, tallies of peak current drains, typical minimum charge levels, tallies of times/days when taken off a battery charger and/or used on a jobsite, etc.), sequential summary statistics (e.g., sequential logs with metadata such as date/time taken off or put on a battery charger, peak current draw, charge rates, impedance estimates, tools placed on, etc.), logs of time-based or order-based charging and/or discharging aspects, raw sensor data, and/or power tool data. However, it should be appreciated that the data may not be limited to the examples above. The data may include any other suitable data for communication between the battery charger 102 and the battery pack 112, 114. For example, the data may also include a request to use a different baud rate or a different communication protocol, firmware of the battery charger 102 or the battery pack 112, 114 (e.g., for a firmware update), or internal parameters (for an update to parameters stored on the battery charger 102 and/or the battery pack 112, 114).

In some aspects of this disclosure, the battery information may include the battery electrical characteristic of the battery pack 112, 114 indicating the state of charge of the battery pack, the terminal voltage of the battery pack, the open-circuit voltage of the battery pack. For example, the charger electronic controller 210 of the battery charger 102 and/or the battery electronic controller 310 of the battery pack 112, 114 may determine a predetermined state of charge (e.g., a full charge (100%), a given max charge target (80%), or any other suitable state of charge) to operate for a sufficient period of time to communicate data. Then, the charger electronic controller 210 of the battery charger 102 and/or the battery electronic controller 310 of the battery pack 112, 114 may communicate the data when the state of charge of the battery pack 112, 114 is above the predetermined state of charge. Here, communicating the data may indicate transmitting, receiving, uploading, and/or synchronizing the data. In other examples, the battery charger 102 and/or battery pack 112, 114 may communicate the data when another suitable battery electrical characteristic (e.g., the terminal voltage of the battery pack, or the open-circuit voltage of the battery pack) is above the predetermined level of the battery electrical characteristic. Thus, the data communication between the battery charger 102 and the battery pack 112, 114 can be performed without the risk to cease the communication due to insufficient battery energy. Further, in the event that a user desires to have the battery pack sufficiently charged for further use as soon as possible, such charging is not delayed by data communications that may not be particularly urgent.

In other aspects of this disclosure, the battery information may include the battery temperature 615 as explained above. In such examples, the battery charger 102 and/or the battery pack 112, 114 may communicate data when the battery pack is in a suboptimal state for charging the battery pack 112, 114. For example, the suboptimal state for charging the battery pack 112, 114 may indicate a battery temperature that is above a high thermal limit (e.g., above 45° C.) or below a low thermal limit (e.g., below 5° C.). In the suboptimal state, the battery charger 102 and/or the battery pack 112, 114 may still communicate data. Thus, the battery charger 102 and/or the battery pack 112, 114 may increase efficiency and effectiveness of data communication by communicating data when it is not optimal to charge the battery pack 112, 14.

In further aspects of this disclosure, the battery information may include a replacement battery availability indication as explained above. The replacement battery availability indication may indicate that the data communication between the battery charger 102 and the battery pack 112, 114 may not be necessarily disrupted due to the replacement or alternative battery is available. Thus, the battery charger 102 and/or the battery pack 112, 114 may communicate data any time based on the replacement battery availability indication.

In further aspects of this disclosure, the battery information may include a charging status of the battery pack 112, 114. The battery charger 102 and/or the battery pack 112, 114 may communicate data based on the charging status of the battery pack 112, 114. For example, the data communication may not be performed when the battery charger 102 is in the charging status. Thus, the battery charger 102 and/or the battery pack 112, 114 may communicate data when the battery charger 102 does not convey constant charging current or the voltage of the battery pack 112, 114 reaches the voltage peak (e.g., the topping voltage or the saturation voltage).

In further aspects of this disclosure, the battery information may include charging statuses of the battery packs in the battery charger 102. In some examples, the battery charger 102 may charge a limited number (e.g., one or two) of battery packs. Thus, when the battery charger 102 is charging another battery pack, the battery charger 102 might not be able to charge the battery pack 112, 114. Since the battery charger 102 may not be able to charge the battery pack 112, 114, the battery charger 102 and/or the battery pack 112, 114 may communicate data at this time. Thus, the battery charger 102 and/or the battery pack 112, 114 may communicate data when another battery in the battery charger 102 is in the charging status.

In further aspects of this disclosure, battery information may include a charge-transfer alternating use indication. In some examples, the battery charger 102 may alternate exchanging a portion of the data and enabling battery charging based on the charge-transfer alternating use indication. In some examples, the battery charger 102 may enable the charge-transfer alternating use that indicates that the battery charger can alternate: charging the battery pack 112, 114 and communicating data. For example, the battery charger 102 may partition the data into multiple portions and iteratively communicate the data, portion by portion, while charging the battery pack for short periods of time between communications of respective portions of the data. The examples may be suitable for communicating large sized data that may be partitioned into several portions of the data.

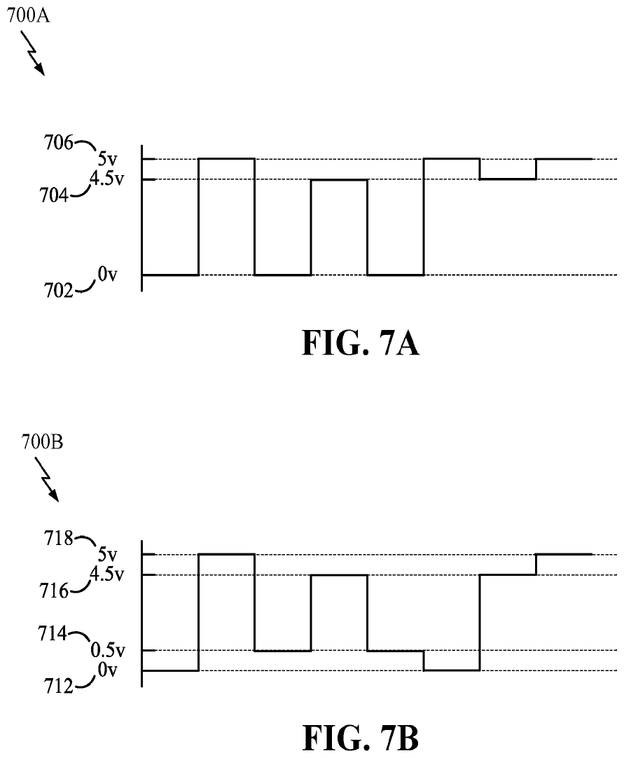

FIG. 7 illustrates examples of waveform using multi-valued signals 700A and 700B. The multi-valued signals 700A and 700B is described below as being used by the battery charger 102 and the battery pack 112, 114 of the system 100 as illustrated in FIGS. 1-3, but may be similarly applicable to other chargers (see, e.g., FIGS. 9A-9C) and/or battery packs (see, e.g., FIGS. 10A-10D). In some examples, the multi-valued signals 700A and 700B may indicate data in communication between the battery charger 102 and the battery pack 112, 114 as illustrated in FIG. 6. Thus, the data communicated using multi-valued signals may include the battery charger 102 transmitting the data to the battery pack 112,114: the battery pack 112,114 transmitting the data to the battery charger 102, or a combination thereof.

In some examples, using a ternary signal or more than three nominal voltages or states may increase the baud rate and protocols for communication. In some examples of FIG. 7A, a data communication signal may employ three voltages (e.g., 0) volt (702), 4.5 volts (704), and 5 volt (706)) for data transfer. The voltage levels (0 v, 4.5 v, and 5 v) of the ternary signal are a mere example. The voltage levels (0 v, 4.5 v, and 5 v) of the ternary signal in other embodiment may be other voltage levels (e.g., 0 v, 0.5 v and 5 v). In other examples of FIG. 7B, a data communication signal may employ four voltages (e.g., 0 volt (712), 0.5 volt (714), 4.5 volts (716), and 5 volt (718)) for data transfer. In some scenarios, two voltages (e.g., 0) v and 0.5, or 4.5 v and 5 v) may be sufficiently close for a legacy battery charger to receive the two voltages as the same value (e.g., digital low or digital high). Accordingly, in some examples, data to be communicated between the battery pack 112,114 and the battery charger 102 may be translated or converted to a base-3 system (e.g., from a base-2 system that may be used by the controllers 210 and/or 310), and then transmitted using the ternary signals. Upon receipt, the data set may be converted back to base-2 (binary) or another number base used by the receiving controller (e.g., the controller 210 or 310). A similar conversion, transmission, and conversion may also be used for signals having more than three nominal voltages or states (e.g., such as shown in FIG. 7B). By using a ternary or higher state signaling protocol, more data may be communicated at a particular instance in time than in a binary signal.

In some examples, the intermediate voltages (e.g., 0.5 v or 4.5 v) may convey different information from two binary values using the low (0 v) or high (5 v) voltages. For example, the intermediate voltages may serve as a request to switch to a higher baud rate, a different communication protocol, and/or other information. In other examples, the use of intermediate voltages may be used for temporary purposes. For example, two close voltages, 0) v and 0.5 v, may be normally used as a digital low value, while two other close voltages, 4.5 v and 5 v, may be used as a digital high value. However, the intermediate voltages may be temporarily used for a handshake that allows new protocols and/or faster baud rates. A legacy battery pack and/or charger may not recognize the intermediate voltages (instead interpreting these signals as a digital high or digital low value) and, thus, may not provide a handshake response or acknowledgement. In response to not receiving a particular handshake response or acknowledgement, the requesting battery pack or charger, in turn, would determine to use the legacy transmission protocol (e.g., with binary signaling) rather than the new protocol with intermediate voltages.

In connection with FIG. 6, the data in communication between the battery charger 102 and the battery pack 112, 114 may include a request to use one or more of a different baud rate or a different communication protocol using the intermediate voltage(s). Also, the data in communication may include other information using the low (0 v) and high (5 v) voltages.

In other examples, similar to multi-valued signals, other over-packing methodologies may exist such as small analog frequencies on a digital line, modulation of clocks, specific clock speeds, more gradual digital rises and falls, and variations or particular impedances, resistances, or capacitances on preferably signal lines.

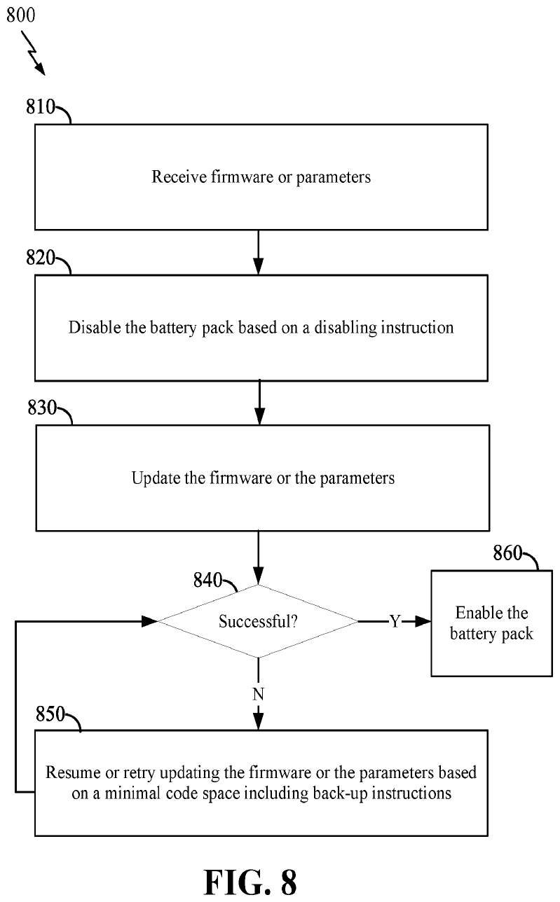

FIG. 8 illustrates a process 800 for firmware or internal parameter update for the battery pack 112, 114. The process 800 is described below as being carried out by the battery pack 112, 114 of the system 100 as illustrated in FIGS. 1-3. For example, the blocks of the process 800 below are described as being executed by the battery electronic controller 310 of the battery pack 112, 114. However, in some embodiments, the process 800 is implemented by another device and/or in another system having additional, fewer, and/or alternative components. For example, the electronic controller 310 as part of one of the battery packs illustrated FIGS. 10A-10D may implement the process 800. Additionally, although the blocks of the process 800 are illustrated in a particular order, in some embodiments, one or more of the blocks may be executed partially or entirely in parallel, may be executed in a different order than illustrated in FIG. 8, or may be bypassed.

Battery packs are often cost constrained and, accordingly, may use simplistic electronic controllers (MCUs). Also, battery packs sometimes have a limited memory space for the firmware. One approach to improve the utility of batteries, especially over their life, is to reprogram them with new firmware. However, updating and transferring firmware can be a time-consuming process. Similar to data transfer illustrated in FIG. 6, updating firmware can take time and pins (or other interfacing resources). Thus, the battery pack 112, 114 may minimally limit other charger functions, ensure the update is successful, and/or optimize the battery pack for some goal by adaptively updating firmware and/or internal parameters as described below.

In some examples, the battery electronic controller 310 of the battery pack 112, 114 may determine the battery information and communicate data at a timing that is based on the battery information as illustrated in FIG. 6. Here, the data received by the battery electronic controller 310 as part of the communication may include or indicate battery pack firmware and/or battery pack parameters. The battery pack firmware may, for example, provide the low-level control for battery pack's hardware (e.g., battery cells 340, electronic components 350, battery electronic controller 310, and/or transceiver 344). The internal parameters may, for example, facilitate setting the battery pack system. In some examples, the battery pack parameters may define an operation mode of the firmware. The battery pack parameters may additionally or alternatively include a discharge parameter, a maximum lower voltage, a maximum upper voltage, ideal or desired charge rates, thermal limits, current overload thresholds, among other parameters of the battery pack 112,114.

In block 810, the battery electronic controller 310 of the battery pack 112, 114 may receive the data that includes the battery pack firmware or the battery pack parameter. The battery electronic controller 310 may receive the battery pack firmware or the battery pack parameter at a timing that is based on the battery information illustrated in FIG. 6. In some examples, due to the size of the firmware or the parameter and the criticality on the battery pack 112, 114, the battery electronic controller 310 may receive the data at a particular time (e.g., at the least disrupting time or another time identified as a time unlikely to be disruptive to use of the battery pack 112, 114, such as at midnight)). In some instances, the battery pack 112, 114, the battery charger 102, or the server 126 may determine the particular time by tracking when the battery pack 112, 114 is received and removed by the battery charger 102. In other examples, the user may determine when the battery pack 112, 114 receives the battery pack firmware or the battery pack parameter. In other instances, when the battery charger 102 may receive multiple battery packs 112, 114, the battery charger may prioritize, limit, or restrict the firmware or parameter update depending on which battery packs are received by the battery charger 102. When the battery charger 102 may charge one or two battery packs at a time, the battery charger 102 may prioritize the update for a battery pack that is not in a charging state.

In block 820, the battery pack 112, 114 may disable the battery pack 112, 114 based on a disabling instruction. For example, the battery electronic controller 310 may determine that the data includes a disabling instruction or the disabling instruction may be part of a firmware or parameter update procedure of the battery pack 112, 114. The disabling instruction may indicate that the battery pack 112, 114 is to be disabled when the battery electronic controller 310 receives or updates the battery pack firmware or battery pack parameter until the battery electronic controller 310 enables the battery pack 112, 114. For example, the disabling instruction may prevent the battery pack 112, 114 from receiving charging current (or full charging current), providing power to a power tool, communicating data, and/or being removed from the battery charger 102. Thus, when the battery electronic controller 310 receives or updates the battery pack firmware or the battery pack parameter, the battery pack 112, 114 may not be able to be charged (or at least receive a minimum amount of charging current), transfer/receive data, be used by a power tool, or even be taken out from the battery charger 102. In other embodiments, the battery pack 112,114 could still be charged while receiving or updating the pack firmware or parameter, but may have other functions disabled (e.g., the ability to power a power tool).

In some examples, the battery pack 112, 114 may further include a physical lock to prevent the battery pack 112, 114 from being removed from the battery charger 102 when the battery electronic controller 310 receives or updates the battery pack firmware or the battery pack parameter. For example, when the battery electronic controller 310 disables the battery pack 112, 114 in block 820, the battery electronic controller 310 may lock the battery pack 112, 114 to the battery charger 102 using the physical lock (e.g., a solenoid locking mechanism on the battery rails or the charger interface 342). In some examples, the battery pack 112, 114 or the battery charger 102 may detect a negative force (a pulling force) on the battery pack 112, 114 from the battery charger 102 by a force sensor. Then, the battery electronic controller 310 may lock the battery pack 112, 114 using the physical lock, and the battery pack 112, 114 or the battery charger 102 may show a message indicating that the battery pack firmware or the battery pack parameter is being updated.

In block 830, the battery pack 112, 114 may update the battery pack firmware or the battery pack parameter. For example, the battery electronic controller 310 of the battery pack 112, 114 may replace a part of the battery pack firmware or the battery pack parameter (e.g., by overwriting the firmware or parameter in the memory 330). In other examples, the battery electronic controller 310 of the battery pack 112, 114 may replace the entire battery pack firmware or the entire battery pack parameter. In other examples, the battery electronic controller 310 may store the battery pack firmware or parameter to the battery pack 112, 114 in a portion of a memory of the battery pack 112, 114, not occupied by the current (old) battery pack firmware or parameter such that the current (old) battery pack firmware or parameter remains on the battery pack 112, 114 as a fallback in the event that the firmware or parameter update fails. In such instances, the update in block 830 may include the battery electronic controller 310 updating a pointer or address associated with the battery pack firmware or parameter such that upon a future attempt to load the battery pack firmware or parameter, the newly received battery pack firmware or parameter are retrieved and used, rather than the old battery pack firmware or parameter. In some examples, the battery pack firmware may be received by the pack (in block 810) in a compressed form. Accordingly, in block 830, to update the firmware, the battery pack 112, 114 may decompress the firmware. In some examples, this decompression occurs at time of the update, at a time when not charging, at a time while charging, and/or while receiving the firmware image.

In some examples, the battery pack 112, 114 may store multiple versions of firmware. Accordingly, in block 830, the battery pack 112, 114 may retrieve firmware version information (e.g., which may be a creation date, version number, or other parameter stored along with the firmware or otherwise associated with the firmware) and determine the most recent (newest) or optimal firmware version based on this version information, and then update the battery pack 112, 114 using this firmware version determined to be the most recent or optimal.

In optional block 840, the battery electronic controller 310 of the battery pack 112, 114 may determine whether the update of the battery pack firmware or the battery pack parameter is successful. For example, the battery electronic controller 310 of the battery pack 112, 114 may determine the successful update based on a return value of the update after the battery electronic controller 310 performs the update. For example, the battery pack firmware or the battery pack parameter may include a software function to provide the return value when each step of the update is successfully performed. When any step of the update is not successfully performed, the return value may indicate that the update is not successfully performed. In other examples, the successful update may be determined based on the file size of the updated battery pack firmware or battery pack parameter. For example, the battery electronic controller 310 may receive the file size of the new battery pack firmware or battery pack parameter from the battery charger 102 or the server 126 and compare the received file size with the file size of the updated battery pack firmware or the battery pack parameter on the battery pack 112, 114. When the received file size is the same as the updated file size, the battery electronic controller 310 may determine that the update is successful. In another example, the battery electronic controller 310 may compare a checksum value(s) of the received new battery pack firmware to determine whether the update is successful.

In optional block 850, when the update is not successful, the battery electronic controller 310 may resume or retry updating the battery pack firmware or the battery pack parameter based on a minimal code space including back-up instructions in the memory 320. For example, the battery pack 112, 114 may include back-up instructions in the memory 320. In some examples, the back-up instructions may identify which step of the update is not successful and resume the update from the unsuccessful step. In other examples, the back-up instructions may try updating the whole firmware or the battery pack parameter again. The back-up instructions may occupy in a minimal code space in the memory 320. After resuming or retrying the update, the battery electronic controller 310 may return to block 840 to determine whether the update is successful. Thus, instead of having a full backup for a ‘default’ or old firmware version, in some embodiments, a small back-up (or restore) portion of firmware may remain (not having been overwritten by the update in block 830). This restore portion may provide a minimal amount of code to enable the battery electronic controller 310 to communicate (e.g., with the charger 102 and/or the server 126) to enable another attempt at updating the battery firmware. Using a small restore portion, as opposed to a full back-up firmware, permits a reduction in size of the memory of the battery pack 112, 114 and/or storage of additional instructions or data for other purposes on the battery pack 112, 114. In other embodiments, the battery electronic controller 310 has a full back-up firmware to enable the battery pack 112, 114 to revert back to an older firmware version and still function in the time between a failed update and a successful update.

In block 860, when the update is successful, the battery electronic controller 310 may enable the battery pack 112, 114. For example, the battery electronic controller 310 may unlock the physical lock of the battery pack 112, 114 and enable receiving charging current and/or communicating data with the battery charger 102 and/or the server 126.

In some examples, a battery pack 112, 114 may have a firmware preference setting, e.g., set by a user via mobile device in communication with the battery pack 112, 114, that indicates that the battery pack 112, 114 accepts or is available for a beta or experimental firmware. Use of such experimental firmware may allow A/B (split) testing (where two or more versions of firmware are provided to different packs and the results may be evaluated), data collection, and alpha releases of firmware. In these cases, the firmware may have different criteria for what to put onto a power tool device and what to implement.

In some examples, firmware is communicated to a power tool device (e.g., received by a battery 112, 114 in block 810), but not activated (e.g., in block 830) until a further date or other criteria. The date or criteria may be preset (e.g., in a memory of the battery pack 112, 114) or received with the firmware. This technique allows, for example, users to “opt-in to new firmware” without having to wait for firmware to download at point of opt-in.

In some of the examples described herein, a power tool device (e.g., a battery pack 112, 114 or charger 102) stores or supports multiple firmware revisions simultaneously. For the power tool device to do so, the power tool device may have an increased memory size relative to a typical power tool device (e.g., chargers and battery packs may typically have relatively small memories unable to store multiple firmware versions). In some examples, the memory may be multiple kilobytes or multiple megabytes. In some examples, this memory may be one or more external memory chips selectively coupled to the power tool device, such as via an insertable module (e.g., a USB flash driver) for ease of transferring. The memory may have other uses when not being used for firmware updates, such as datalogging.

In some examples, the firmware transmission (block 810) and/or the firmware update (block 830) may take place in an intermittent manner due to the length of time to transmit or update and/or the limited availability of memory of a power tool device. The resulting partial transmissions or updates allow for the power tool devices (e.g., battery packs 112, 114) in the field to eventually get fully updated even in low bandwidth environments. This intermittent firmware transmission and/or updating can also include transmitting and/or updating only certain sections of firmware rather, than the entire device firmware.

In some examples, the charger 102 may selectively obtain firmware based on determining that a battery pack is nearby and based on battery information for the battery pack. This obtained firmware may then be communicate by the charger 102 to the battery pack 112, 114, for example, in block 810 of the process 800. For example, the charger 102 may receive a communication from a battery pack 112, 114 indicating that the battery pack 112, 114 is nearby (e.g., within communication range), and including battery information (e.g., an identifier for the battery pack). In other examples, the charger 102 may determine that the battery 112, 114 is nearby based on the battery 112, 114 being placed on a charger 102, logs from other nearby tools, battery packs, and/or chargers being shared with the charger 102, and other battery information sources.

The charger 102 may then communicate with the server 126 via access point 122 and network 124 (see FIG. 1) to request a current firmware for the battery pack 112, 114. The request may include the identifier or an indication of the type of battery pack determined by the charger 102 based on the identifier, such that the server 126 may respond with appropriate firmware suitable for the battery pack 112, 114.

Additionally, in some examples, the firmware provided by the charger 102 to the battery pack 112, 114 is firmware for a power tool to which the battery pack 112, 114 may be coupled (e.g., power tool 132, 142, 152, 162, etc.). The battery pack 112, 114 may then, upon a further coupling with such power tool, communicate the firmware to the power tool. The power tool may then update its firmware, for example, using similar principles as described above with respect to block 830 and, optionally, blocks 840, 850, and 860.

In some examples, a power tool device, whether battery pack 112, 114, charger 102, or power tool 132, 142, 152, 162, may request firmware from the server 126 for a device currently or recently in electric communication with the power tool device. The power tool device may then communicate that firmware to the other device, which, in turn, may update its firmware based on the received firmware (e.g., using similar principles as described above with respect to block 830 and, optionally, blocks 840, 850, and 860). In some cases, the firmware request may be met with an override that encourages a power tool device to change its firmware request. [Abbott]

In some embodiments, one or more of the determinations of one or more of the above processes is performed using or with the assistance of a machine learning algorithm implemented by the electronic controller performing the determination (e.g., the battery pack controller 310 or the charger electronic controller 210) or by an electronic controller in communication with the battery pack controller 310 and/or the charger electronic controller 210.

For example, in block 420 of FIG. 4, the charger electronic controller 210 may use a machine learning algorithm to process data to determine the battery information including the tandem use information, the end-of-use information, and/or the user preference information. For example, the machine learning algorithm may implement a trained artificial neural network or other classifying algorithm that receives various data about the battery packs 112, 114, the battery charger 102, and other example information noted above with respect to the process 400 used to make the determination in block 420. The machine learning algorithm may then generate an output (or classification), based on the input, that indicates the tandem use information, the end-of-use information, and/or the user preference information. This determined battery information may then be used in block 430 as a basis on which the one or more power tool battery packs are charged, as previously described with respect to block 430 above. Similarly, in block 610 of FIG. 6, the charger electronic controller 210 or battery electronic controller 310 may use a machine learning algorithm to process data to determine the battery information including the battery electrical characteristic, battery temperature, replacement battery availability indication, charging status of the battery pack, and/or charge-transfer alternating use indication. For example, the machine learning algorithm may implement a trained artificial neural network or other classifying algorithm that receives various data about the battery packs 112, 114, the battery charger 102, and other example information noted above with respect to the process 600 used to make the determination in block 610. The machine learning algorithm may then generate an output (or classification), based on the input, that indicates the battery information. This determined battery information may then be used in block 620 as a basis on which the data is communicated, as previously described with respect to block 620 above.

As noted, the machine learning algorithm may be implemented on an electronic controller that is in communication with the electronic controller performing the determinations of blocks 420 and/or 610. For example, the battery pack controller 310 may perform a determination (e.g., of block 420 or block 610) by communicating with the charger electronic controller 210 on which the machine learning algorithm is implemented. The machine learning algorithm may process data and provide the battery information as output, which the charger electronic controller 210 may communicate back to the battery pack controller 310. The battery pack controller 310 may then determine the battery information upon receipt of the output from the charger electronic controller 210. Similarly, the battery pack controller 310 may perform a determination (e.g., of block 420 or block 610) by communicating with an electronic controller of the server 126, the access point 122, or a power tool, on which the machine learning algorithm is implemented. Similarly, the charger electronic controller 210 may perform a determination by communicating with the battery pack controller 310 or an electronic controller of the server 126, the access point 122, or a power tool, on which the machine learning algorithm is implemented.

The power tool battery packs 112,114 and power tool battery charger 102 described herein are just some examples of such packs and chargers. In some embodiments, the power tool battery charger 102 has another configuration. For example, the power tool battery charger 102 may have additional or fewer charging docks, may have a different electrical and/or mechanical interface for interfacing with a power tool battery pack, and/or may be configured to charge a different type (or combinations of types) of power tool battery packs (e.g., having different capacities or nominal voltage levels). For example, FIGS. 9A-9C illustrate three further examples of power tool battery chargers 900, 905, and 910. Each of the power tool battery pack chargers 900, 905, and 910 may perform the functionality of the power tool battery charger 102 above. For example, one or more of the chargers 900, 905, 910 may be configured to implement the processes 400, 500, 600, 800 described herein. Additionally, at least in some embodiments, the diagram of the power tool battery charger 102 of FIG. 2 similarly applies to the chargers 900, 905, and 910.

Similarly, in some embodiments, the power tool battery packs 112, 114 have another configuration. For example, the power tool battery packs 112, 114 may have a different electrical and/or mechanical interface for interfacing with power tools and/or power tool battery pack chargers and/or may be configured to be charged by a different type of power tool battery chargers (e.g., one or more of the chargers 900, 905, 910), may have a different capacity, and/or may have a different nominal voltage level. For example, FIGS. 10A-10D illustrate four further examples of power tool battery packs 1000, 1005, 1010, 1015. Each of the power tool battery packs 1000-1015 may perform the functionality of the power tool battery packs 112, 114 above. For example, one or more of the packs 1000-1015 may be configured to implement, be charged as a result of, or communicate data in accordance with the processes 400, 500, 600, 800. Additionally, at least in some embodiments, the diagram(s) of the power tool battery packs 112, 114 of FIG. 3 similarly applies to the packs 1000-1015.

FIGS. 9A-C respectively illustrate the power tool battery pack chargers 900, 905, and 910. As illustrated, the charger 900 includes two charging docks, the charger 905 includes four charging docks, and the charger 910 includes one charging dock. Each charging dock is configured to receive and provide charging current to one power tool battery pack at a time. To receive a power tool battery pack, the charging dock may electrically and mechanically interface with the power tool battery pack. Accordingly, each of the chargers 900, 905, and 910 is configured to electrically and mechanically interface with a power tool battery pack via each respective charging dock. Electrically interfacing may include electrical terminals of the pack and a charger (e.g., one of the respective chargers 900, 905, and 910) contacting one another, may include a wireless connection for wireless power transfer (e.g., between inductive or capacitive elements of the pack and the charger, or a combination thereof. Mechanical interfacing may include the pack being received in a receptacle of a charger (e.g., one of the respective chargers 900, 905, and 910), a mating of physical retention structures of the pack and the charger, or a combination thereof. In some examples, the charger 900 includes fewer or additional charging docks. In some examples, the charger 905 includes fewer or additional charging docks. In some examples, the charger 910 includes fewer or additional charging docks. In some examples, the power tool battery pack charger 900 is configured to receive and charge power tool battery packs (e.g., packs 112 and 114) having a nominal voltage of approximately 18 volts, a nominal voltage between 16 volts and 22 volts, or another amount. In some examples, the power tool battery pack charger 905 is configured to receive and charge power tool battery packs (e.g., packs 1000 and 1005) having a nominal voltage of approximately 12 volts, a nominal voltage between 8 volts and 16 volts, or another amount. In some examples, the power tool battery pack charger 910 is configured to receive and charge power tool battery packs (e.g., packs 1010 and 1015) having a nominal voltage of approximately 72 volts, a nominal voltage between 60 volts and 90 volts, or another amount. Accordingly, at least in some embodiments, the charger 910 is generally configured to charge battery packs having a higher nominal voltage than the packs charged by the chargers 905 and 900, and the charger 900 is generally configured to charge battery packs having a higher nominal voltage than the packs charged by the charger 905.

FIGS. 10A-10D respectively illustrate the power tool battery packs 1000, 1005, 1010, and 1015. Each pack 1000-1025 is configured to be received and charged by a power tool battery charger (e.g., one of the chargers 900, 905, and 910). Each pack 1000-1025 is further configured to be received by provide power to a power tool. To be received by a charger or power tool, each battery pack 1000-1025 may electrically and mechanically interface with the charger and (at a different time) with a power tool. In some examples, the power tool battery packs 1000 and 1005 have a nominal voltage of approximately 12 volts, of between 8 volts and 16 volts, or another amount. In some examples, the power tool battery pack 1000 has a larger capacity than the pack 1005, generally providing a longer run time than the pack 1005 when operating under similar circumstances. To achieve additional capacity, the pack 1000 may include an additional set of battery cells relative to the pack 1005. For example, the pack 1005 may include a set of series-connected battery cells, while the battery pack 1000 may include two or more sets of series-connected battery cells, with each set being connected in parallel to the other set(s) of cells.

In some examples, the power tool battery packs 1010 and 1015 have another nominal voltage of approximately 72 volts, of between 60 volts and 90 volts, or another amount. In some examples, the power tool battery pack 1010 has a larger capacity than the pack 1015, generally providing a longer run time than the pack 1015 when operating under similar circumstances. To achieve additional capacity, the pack 1010 may include an additional set of battery cells relative to the pack 1015. For example, the pack 1015 may include a set of series-connected battery cells, while the battery pack 1010 may include two or more sets of series-connected battery cells, with each set being connected in parallel to the other set(s) of cells.

Accordingly, at least in some embodiments, the packs 1010 and 1015 have a higher nominal voltage than the packs 112, 114, 1000, and 1005; and the packs 112 and 114 have a higher nominal voltage than the packs 1000 and 1005.

It is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including.” “comprising.” or “having” and variations thereof herein is meant to encompass the items listed thereafter and equivalents thereof as well as additional items. Unless specified or limited otherwise, the terms “mounted,” “connected.” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise limited or defined, discussion of particular directions is provided by example only, with regard to particular embodiments or relevant illustrations. For example, discussion of “top,” “front,” or “back” features is generally intended as a description only of the orientation of such features relative to a reference frame of a particular example or illustration. Correspondingly, for example, a “top” feature may sometimes be disposed below a “bottom” feature (and so on), in some arrangements or embodiments. Further, references to particular rotational or other movements (e.g., counterclockwise rotation) is generally intended as a description only of movement relative a reference frame of a particular example of illustration.

In some embodiments, including computerized implementations of methods according to the disclosure, can be implemented as a system, method, apparatus, or article of manufacture using standard programming or engineering techniques to produce software, firmware, hardware, or any combination thereof to control a processor device (e.g., a serial or parallel processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the disclosure can be implemented as a set of instructions, tangibly embodied on a non-transitory computer-readable media, such that a processor device can implement the instructions based upon reading the instructions from the computer-readable media. Some embodiments of the disclosure can include (or utilize) a control device such as an automation device, a computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). Also, functions performed by multiple components may be consolidated and performed by a single component. Similarly, the functions described herein as being performed by one component may be performed by multiple components in a distributed manner. Additionally, a component described as performing particular functionality may also perform additional functionality not described herein. For example, a device or structure that is “configured” in a certain way is configured in at least that way, but may also be configured in ways that are not listed.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally it should be appreciated that a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the scope or spirit of the claimed subject matter.

Certain operations of methods according to the disclosure, or of systems executing those methods, may be represented schematically in the figures or otherwise discussed herein. Unless otherwise specified or limited, representation in the figures of particular operations in particular spatial order may not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular embodiments of the disclosure. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component.” “system,” “module,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

As used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

As used herein, unless otherwise defined or limited, the phase “and/or” used with two or more items is intended to cover the items individually and the items together. For example, a device having “a and/or b” is intended to cover: a device having a (but not b): a device having b (but not a); and a device having both a and b.

This discussion is presented to enable a person skilled in the art to make and use embodiments of the disclosure. Various modifications to the illustrated examples will be readily apparent to those skilled in the art, and the generic principles herein can be applied to other examples and applications without departing from the principles disclosed herein. Thus, embodiments of the disclosure are not intended to be limited to embodiments shown, but are to be accorded the widest scope consistent with the principles and features disclosed herein and the claims below: The following detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

Various features and advantages of the disclosure are set forth in the following claims.

1. A power tool battery charger, comprising:
one or more charging docks, each charging dock including a charging interface for providing charging current; and
a charger electronic controller including a processor and a memory,
wherein the charger electronic controller is configured to:
identify one or more battery packs received by the one or more charging docks;
determine battery information for the one or more battery packs, the battery information indicating one or more of:
tandem use information for the one or more battery packs,
end-of-use information for the one or more battery packs, or
user preference information for the one or more battery packs derived from one or more of: past charging, manner-of-insertion, a user interface on a battery pack of the one or more battery packs, or a wireless interface; and
charge the one or more battery packs based on the battery information.

2. The power tool battery charger of claim 1, wherein the one or more battery packs include two or more battery packs, and
wherein the battery information indicates tandem use information for the two or more battery packs, the tandem use information indicating that one or more of: the two or more battery packs have been used on a power tool in tandem or the two or more battery packs are intended for use on a power tool in tandem.

3. The power tool battery charger of claim 2, wherein the battery information is based on the charger electronic controller determining that one or more of:
the two or more battery packs are received by the power tool battery charger at substantially a same time,
the two or more battery packs have substantially equal voltage levels when the two or more battery packs are received by the power tool battery charger,
the two or more battery packs have substantially equal capacities,
the two or more battery packs have been used in tandem before,
the charger electronic controller received an indication from the two or more battery packs that the two or more battery packs are to be used in tandem,
the charger electronic controller received a request via a user interface that the two or more battery packs are to be used in tandem, or
a power tool within communication range is configured to use or has used battery packs in tandem.

4. The power tool battery charger of claim 2, wherein to charge the two or more battery packs, the charger electronic controller is configured to charge a first battery pack of the two or more battery packs to a first predetermined voltage with a higher priority than a second battery pack of the two or more battery packs, the first battery pack having a battery level lower than the second battery pack.

5. (canceled)

6. The power tool battery charger of claim 4, wherein to charge the first battery pack to the first predetermined voltage, the charger electronic controller is configured to:
charge the first battery pack to the first predetermined voltage with a higher priority than the second battery pack;
charge the second battery pack to the first predetermined voltage; and
charge the two or more battery packs in parallel to a second predetermined voltage.

7. The power tool battery charger of claim 1, wherein the battery information indicates end-of-use information for the one or more battery packs.

8. The power tool battery charger of claim 7, wherein the battery information is based on the charger electronic controller determining that one or more of:
the one or more battery packs reached a low voltage at which a power tool using the one or more battery packs ceases operation,
the one or more battery packs reached a first thermal limit at which the one or more battery packs cease operation,
the power tool that used the one or more battery packs reached a second thermal limit at which the power tool ceases operation,
the one or more battery packs reached a predetermined reduced level of performance, or the one or more battery packs reached a predetermined level of capacity loss.

9. The power tool battery charger of claim 8, wherein the battery information is based on the charger electronic controller determining that the one or more battery packs reached the first thermal limit or the power tool using the one or more battery packs reached the second thermal limit, and
wherein to charge the one or more battery packs, the charger electronic controller is configured to: charge the one or more battery packs less than a full charge capacity of the one or more battery packs.

10. The power tool battery charger of claim 8, wherein the battery information is based on the charger electronic controller determining that the one or more battery packs reached the first thermal limit, and
wherein to charge the one or more battery packs, the charger electronic controller is configured to: charge the one or more battery packs based on a temperature of the one or more battery packs.

11. The power tool battery charger of claim 7, wherein the charger electronic controller is further configured to one or more of:
obtain the end-of-use information from the one or more battery packs, or
determine the end-of-use information based on one or more of: an ambient temperature, a time of the one or more battery packs to be placed in the power tool battery charger, or prior end-of-use information of the one or more battery packs.

12. (canceled)

13. The power tool battery charger of claim 1, wherein the battery information indicates user preference information for the one or more battery packs derived from one or more of: past charging, manner-of-insertion, or a wireless interface.

14. The power tool battery charger of claim 13, wherein the battery information is based on the charger electronic controller determining that one or more of:
the one or more battery packs had a higher priority than another battery pack in the power tool battery charger,
the one or more battery packs were charged with a fast charging rate that is faster than a normal charging rate,
the one or more battery packs were removed from the power tool battery charger before being fully charged, or
the one or more battery packs were received by the power tool battery charger with a high speed that is faster than a threshold speed or at a high force that is more forceful than a threshold force.

15. The power tool battery charger of claim 14, wherein the battery information is based on the charger electronic controller determining that the one or more battery packs had the higher priority than another battery pack in the power tool battery charger, and
wherein to charge the one or more battery packs, the charger electronic controller is configured to: charge the one or more battery packs with the higher priority than a different battery pack in the power tool battery charger.

16. The power tool battery charger of claim 14, wherein the battery information is based on the charger electronic controller determining that the one or more battery packs were charged with the fast charging rate, and
wherein to charge the one or more battery packs, the charger electronic controller is configured to: charge the one or more battery packs with the fast charging rate.

17. The power tool battery charger of claim 14, wherein the battery information is based on the charger electronic controller determining that the one or more battery packs were removed from the power tool battery charger before being fully charged, and
wherein to charge the one or more battery packs, the charger electronic controller is configured to: charge the one or more battery packs with the fast charging rate.

18. The power tool battery charger of claim 14, wherein the battery information is based on the charger electronic controller determining that the one or more battery packs were received by the power tool battery charger with the high speed or the high force on the power tool battery charger, and
wherein to charge the one or more battery packs, the charger electronic controller is configured to: charge the one or more battery packs with the higher priority than a different battery pack in the power tool battery charger or with the fast charging rate.

19. (canceled)

20. A method of charging with a power tool battery charger, comprising:
identifying, by a charger electronic controller of a power tool battery charger, one or more battery packs received by one or more charging docks of the power tool battery charger, each charging dock including a charging interface for providing charging current;
determining battery information for the one or more battery packs, the battery information indicating one or more of:
tandem use information for the one or more battery packs,
end-of-use information for the one or more battery packs, or
user preference information for the one or more battery packs derived from one or more of: past charging, manner-of-insertion, a user interface on a battery pack of the one or more battery packs, or a wireless interface; and
charging the one or more battery packs based on the battery information.

21. The method of claim 20, wherein the one or more battery packs include two or more battery packs, and
wherein the battery information indicates tandem use information for the two or more battery packs, the tandem use information indicating that one or more of: the two or more battery packs have been used on a power tool in tandem or the two or more battery packs are intended for use on a power tool in tandem.

22.-25. (canceled)

26. The method of claim 20, wherein the battery information indicates end-of-use information for the one or more battery packs.

27.-31. (canceled)

32. The method of claim 20, wherein the battery information indicates user preference information for the one or more battery packs derived from one or more of: past charging, manner-of-insertion, or a wireless interface.

33.-72. (canceled)
